(19) United States
(12) Patent Application Publication
(10) Pub. No.: US 2026/0280839 A1
(43) Pub. Date: Sep. 17, 2026

(54) COMMUNICATION DEVICE, COMMUNICATION METHOD, AND IMAGE SENSOR

(71) Applicant: Sony Semiconductor Solutions Corporation, Kanagawa (JP)

(72) Inventors: Akihito Okamoto, Kagoshima (JP); Daisaku Nakahara, Kagoshima (JP); Minehiko Tateno, Kagoshima (JP)

(21) Appl. No.: 19/156,649

(22) PCT Filed: Feb. 20, 2024
(86) PCT No.: PCT/JP2024/006016

§ 371 Date: Aug. 14, 2025

(30) Foreign Application Priority Data
Feb. 28, 2023 (JP) 2023-030162

(51) Int. Cl. H04L 7/00; H04L 7/033; H04N 25/76; H04N 25/78

(52) U.S. Cl. CPC H04L 7/0008; H04L 7/033; H04N 25/7795; H04N 25/78

(57) ABSTRACT

A plurality of signal processing units each of which outputs an output clock signal and output data that is based on input data and synchronized with the output clock signal to a corresponding lane among a plurality of lanes, and a first selection circuit that selects, according to a reference lane selection signal to select a reference lane from the plurality of lanes, an output clock signal corresponding to the reference lane among the output clock signals respectively output from the plurality of signal processing units, and performs an output thereof to each of the plurality of signal processing units are included. Each of the plurality of signal processing units aligns and outputs the output clock signal and the output data on the basis of either a reference clock signal or the output clock signal output from another signal processing unit among the plurality of signal processing units.

### FIELD

The present disclosure relates to a communication device, a communication method, and an image sensor.

### BACKGROUND

As image quality and a frame rate of an image sensor have been increased in recent years, a technology of reading image data acquired by the image sensor at high speed has been required. For example, a technology of reading image data at high speed by serially transmitting a plurality of pieces of image data in parallel has been proposed. Patent Literature 1 discloses a technology of adjusting synchronization of the pieces of image data serially transmitted in parallel.

### CITATION LIST

### Patent Literature

Patent Literature 1: Japanese Patent Application Laid-Open No. 2019-036833

### SUMMARY

### Technical Problem

However, Patent Literature 1 has a configuration in which a synchronization code is added in units of frames on a transmission side and parallel lanes are compared and synchronized on a reception side, and switching from standing by to a normal operation is not easy, which is a factor of lowering transfer efficiency of the image data.

An object of the present disclosure is to provide a communication device, a communication method, and an image sensor capable of efficiently transferring data by using a plurality of lanes.

### Solution to Problem

For solving the problem described above, a communication device according to one aspect of the present disclosure has a plurality of signal processing units each of which outputs an output clock signal and output data that is based on input data and synchronized with the output clock signal to a corresponding lane among a plurality of lanes; and a first selection circuit that selects, according to a reference lane selection signal to select a reference lane from the plurality of lanes, an output clock signal corresponding to the reference lane among the output clock signals respectively output from the plurality of signal processing units, and performs an output thereof to each of the plurality of signal processing units, wherein each of the plurality of signal processing units aligns and outputs the output clock signal and the output data on a basis of either a reference clock signal or the output clock signal output from another signal processing unit among the plurality of signal processing units.

### BRIEF DESCRIPTION OF DRAWINGS

FIG. 1 is a schematic diagram for describing a data transfer using a plurality of lanes according to an existing technology.

FIG. 2 is a schematic diagram for describing a factor that reduces transfer efficiency of image data in the data transfer using the plurality of lanes according to the existing technology.

FIG. 3 is a schematic diagram for describing an image transfer using a plurality of lanes according to the present disclosure.

FIG. 4 is a block diagram illustrating an exemplary configuration of an electronic device applicable to each embodiment.

FIG. 5 is a block diagram illustrating an exemplary configuration of an image sensor applicable to a first embodiment.

FIG. 6 is a block diagram illustrating an exemplary configuration of a transmission data processing circuit according to the first embodiment.

FIG. 7 is a block diagram illustrating an exemplary configuration of a synchronization circuit applicable to the first embodiment.

FIG. 8 is a block diagram illustrating an exemplary configuration of a clock alignment circuit applicable to the first embodiment.

FIG. 9 is a block diagram illustrating an exemplary configuration of a data alignment circuit applicable to the first embodiment.

FIG. 10 is a schematic diagram illustrating an exemplary data structure of output data applicable to the first embodiment.

FIG. 11 is a block diagram illustrating an exemplary configuration of an image processing unit applicable to the first embodiment.

FIG. 12 is a time chart illustrating exemplary processing in a transmission data processing circuit according to the first embodiment.

FIG. 13 is a flowchart illustrating exemplary processing in the transmission data processing circuit according to the first embodiment.

FIG. 14A is a schematic diagram illustrating a flow of a signal in the processing of the flowchart according to the first embodiment.

FIG. 14B is a schematic diagram illustrating a flow of a signal in the processing of the flowchart according to the first embodiment.

FIG. 15 is a time chart of an example illustrating transmission processing according to the first embodiment.

FIG. 16 is a time chart of an example illustrating reception processing according to the first embodiment.

FIG. 17A is a schematic diagram illustrating an example of a simulation result of the processing according to the first embodiment.

FIG. 17B is a schematic diagram illustrating the example of the simulation result of the processing according to the first embodiment.

FIG. 17C is a schematic diagram illustrating the example of the simulation result of the processing according to the first embodiment.

FIG. 18 is a schematic diagram for describing noise mixture in a case where a new lane is switched to a communication state in the configuration according to the first embodiment.

FIG. 19 is a schematic diagram for describing the noise mixture in a case where the new lane is switched to the communication state in the configuration according to the first embodiment.

FIG. 20A is a block diagram illustrating an exemplary configuration of an image sensor according to a second embodiment.

FIG. 20B is a block diagram illustrating an exemplary configuration of a transmission data processing circuit according to the second embodiment.

FIG. 21 is a time chart of an example for describing an operation according to the second embodiment.

FIG. 22 is a block diagram more specifically illustrating the exemplary configuration of the image sensor according to the second embodiment.

FIG. 23 is a circuit diagram illustrating an exemplary circuit of a transmission control circuit applicable to the second embodiment.

FIG. 24 is a circuit diagram illustrating an exemplary circuit of a slow current superimposition circuit applicable to the second embodiment.

FIG. 25 is a circuit diagram illustrating the exemplary circuit of the slow current superimposition circuit applicable to the second embodiment.

FIG. 26 is a time chart for describing an operation according to the second embodiment.

FIG. 27 is a schematic diagram illustrating an example of simulating an operation by a configuration according to the second embodiment.

### DESCRIPTION OF EMBODIMENTS

In the following, embodiments of the present disclosure will be described in detail on the basis of the drawings. Note that in the following embodiments, overlapped description is omitted by assignment of the same reference sign to the same parts.

Hereinafter, the embodiments of the present disclosure will be described in the following order.
1. Existing technology
2. First embodiment of the present disclosure
   2-1. Technology applicable to the first embodiment
   2-2. Configuration according to the first embodiment
   2-3. Processing according to the first embodiment
3. Second embodiment of the present disclosure
   3-1. Problem of the first embodiment
   3-2. Outline of the second embodiment
   3-3. Specific example of the second embodiment
      3-3-1. Configuration example according to the second embodiment
      3-3-2. Operation example according to the second embodiment
4. Conclusion

The present disclosure relates to a communication device to perform data transfer, and has a configuration of outputting input image data to a transmission circuit that performs data transfer of each of a plurality of lanes after performing alignment of clocks and data for the plurality of lanes. The communication device according to the present disclosure is specifically suitable for use in a transfer of the image data.

### 1. Existing Technology

Prior to description of each embodiment of the present disclosure, an existing technology related to a technology of the present disclosure will be described.

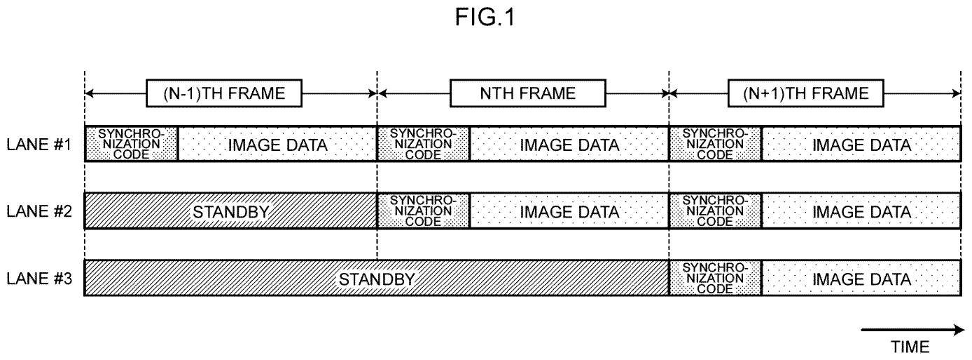

FIG. 1 is a schematic diagram for describing a data transfer using a plurality of lanes according to an existing technology. An example in which a plurality of pieces of image data (video data) is transferred in parallel by utilization of three lanes that are lanes #1, #2, and #3 is illustrated in FIG. 1. A state in which image data is sequentially transferred to the lane #2 and the lane #3 with the lane #1 as a reference lane is illustrated in the example of FIG. 1.

In the existing technology, the image data is generally transferred in units of frames, and the image data is transferred with a predetermined synchronization code being added to a head of each frame on a transmission side. In the example of FIG. 1, a transfer of the image data of the lane #2 is started in synchronization with a transfer of the image data of an Nth frame of the lane #1, and a transfer of the image data of the lane #3 is started in synchronization with a transfer of the image data of an (N+1) th frame of the lane #1.

Incidentally, in recent years, in a field of portable information devices such as a smartphone, a device equipped with an image sensor capable of capturing a video with so-called 4K resolution (about 4000 horizontal pixels×2000 vertical pixels) and a frame rate of 60 frames per second (fps) has appeared. In this case, when a bit depth of one pixel is 16 bits, a transfer rate of the image data read from the image sensor is approximately 8 giga bits per second (Gbps).

Furthermore, an information device equipped with an image sensor capable of capturing video with higher resolution and a higher frame rate such as so-called 8K resolution (about 8000 horizontal pixels×4000 vertical pixels) and a frame rate of 120 fps has been proposed. In this case, when the bit depth of one pixel is 16 bits, the transfer rate of the image data read from the image sensor is approximately 60 Gbps.

In such a manner, as image quality and a frame rate of an image sensor have been increased in recent years, a technology of reading image data acquired by the image sensor at high speed has been required. For example, a technology of reading image data at high speed by serially transferring a plurality of pieces of image data in parallel has been proposed.

While a transfer rate is increased in such a manner, there is also a demand for controlling the increase in speed from a viewpoint of power consumption and design difficulty.

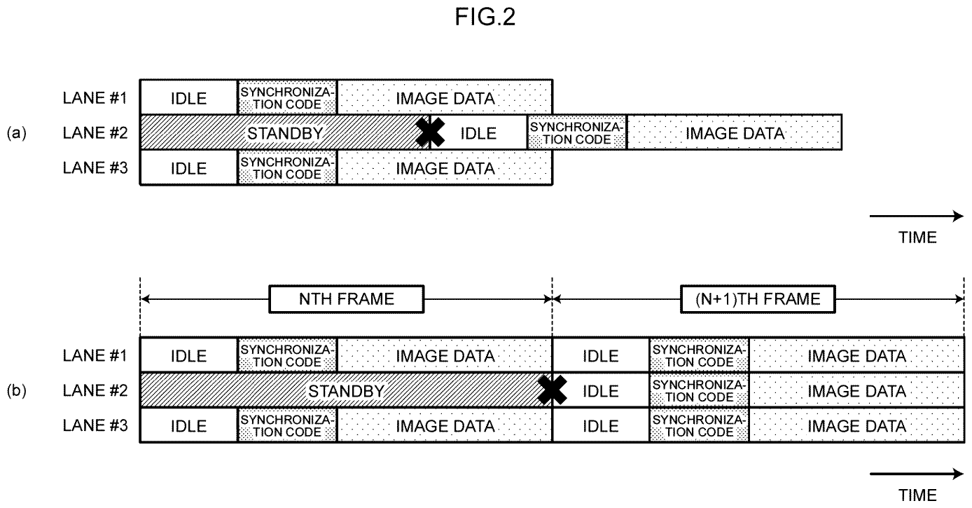

FIG. 2 is a schematic diagram for describing a factor that reduces transfer efficiency of image data in a data transfer using a plurality of lanes according to an existing technology illustrated in FIG. 1. In an example of FIG. 2, a synchronization code is added to each frame, and the image data is transferred after an IDLE code. Note that the IDLE code is used in a case where valid data to be transferred is not output from an image sensor.

A first factor that reduces transfer efficiency of the image data is that an arbitrary lane cannot be switched from a standby state to a communication state during an image data transfer. That is, as indicated by a “x (cross)” sign in a section (a) of FIG. 2, in a case where a state of the lane #2 is switched from the standby state to the communication state during the transfer of the image data in the lane #1, the lane #1 and the lane #2 cannot be synchronized by a synchronization code.

A second factor that reduces the transfer efficiency of the image data is that the standby state can be switched to the communication state only in units of frames. That is, in a section (b) of FIG. 2, in the lane #2, it is necessary to perform switching from the standby state to the communication state at a position indicated by a “x (cross)” sign.

As described above, in the existing technology, since the image data is transferred in units of frames by utilization of the synchronization code, it is difficult to increase the speed of the data transfer.

In addition, in Patent Literature 1 described above, since synchronization adjustment is performed in units of frames, it is difficult to follow switching of telescopy, a wide angle of view, and the like of a moving image in a smartphone having multiple functions, and it is not suitable for data compression, that is, an increase in speed. Furthermore, in Patent Literature 1, a circuit that compares synchronization codes between lanes is required, the number of elements increases due to a wide mounting area, a consumption current increases due to the large number of adjustment steps between transmission processing and reception processing, and downsizing and power saving are difficult.

### Image Transfer Using a Plurality of Lanes According to the Present Disclosure

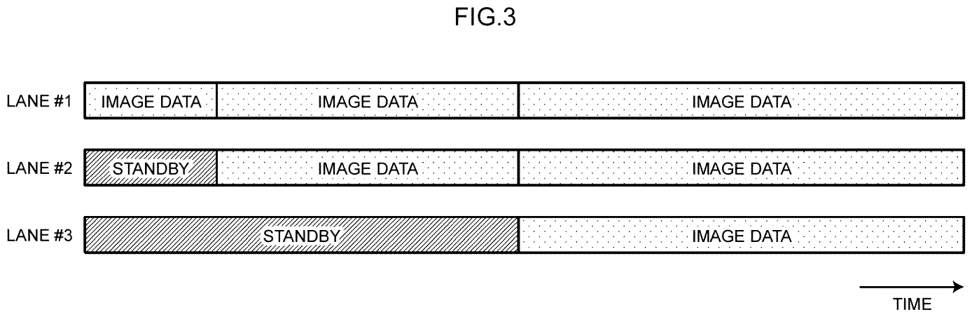

FIG. 3 is a schematic diagram for describing an image transfer using a plurality of lanes according to the present disclosure. In the present disclosure, as illustrated in FIG. 3, a data transfer by each of lanes #1 to #3 can be started from the standby state without using a synchronization code.

As described above, by transferring image data in each of the lanes without using the synchronization code, it is possible to increase an image data period as compared with a case where the synchronization code is used, and it is possible to control a substantial transfer rate related to the data transfer in a case where a speed of the transfer rate is increased. In addition, the image data can be transferred not only in units of frames but also in arbitrary units.

### 2. Embodiment of the Present Disclosure

Next, the first embodiment of the present disclosure will be described.

### 2-1. Technology Applicable to the First Embodiment

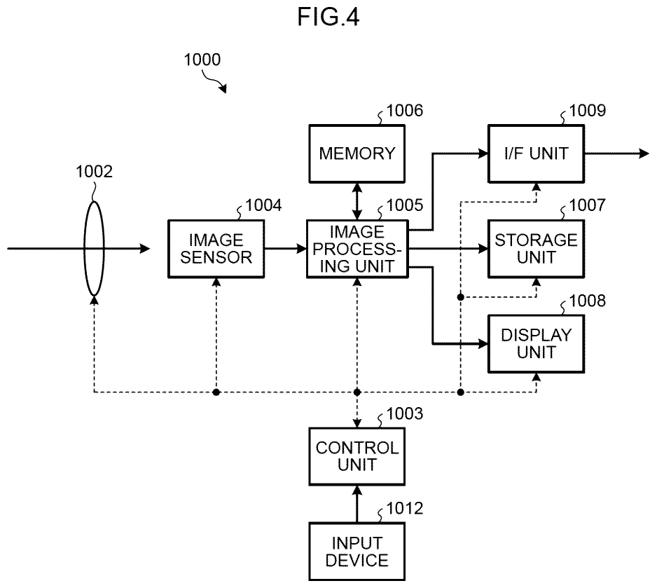

First, a technology applicable to the first embodiment will be described. FIG. 4 is a block diagram illustrating an exemplary configuration of an electronic device applicable to each embodiment. In FIG. 4, an electronic device 1000 includes an optical system 1002, a control unit 1003, an image sensor 1004, an image processing unit 1005, a memory 1006, a storage unit 1007, a display unit 1008, an interface (I/F) unit 1009, and an input device 1012.

Here, as the electronic device 1000, a digital still camera, a digital video camera, a mobile phone or a smartphone with an imaging function, or the like can be applied. Furthermore, a monitoring camera, an in-vehicle camera, a medical camera, or the like can also be applied as the electronic device 1000.

The image sensor 1004 includes, for example, a plurality of photoelectric conversion elements arranged in a matrix array. Each of the photoelectric conversion elements converts received light into an electric charge by photoelectric conversion. The image sensor 1004 includes a drive circuit that drives the plurality of photoelectric conversion elements, a signal processing circuit that reads the electric charge from each of the plurality of photoelectric conversion elements and generates image data on the basis of the read electric charge, and a power supply circuit to supply power to the drive circuit.

The optical system 1002 includes a main lens formed by a combination of one or a plurality of lenses and a mechanism to drive the main lens, and forms an image of image light (incident light) from a subject on a light receiving surface of the image sensor 1004 via the main lens. Furthermore, the optical system 1002 includes an autofocus mechanism that adjusts focus in accordance with a control signal, and a zoom mechanism that changes a zoom ratio in accordance with the control signal. Furthermore, in the electronic device 1000, the optical system 1002 is detachable and can be replaced with another optical system 1002.

The image processing unit 1005 executes predetermined image processing on pixel data output from the image sensor 1004. For example, the image processing unit 1005 is connected to a memory 1006 such as a frame memory, and writes image data output from the image sensor 1004 in the memory 1006. The image processing unit 1005 executes predetermined image processing on the pixel data written in the memory 1006, and writes the pixel data, on which the image processing is performed, again in the memory 1006. Note that the memory 1006 can store the pixel data for one frame as the image data.

The storage unit 1007 is, for example, a non-volatile memory such as a flash memory or a hard disk drive, and stores the image data output from the image processing unit 1005 in a non-volatile manner. The display unit 1008 includes, for example, a display device such as a liquid crystal display (LCD) and a drive circuit that drives the display device, and can display an image based on the image data output by the image processing unit 1005. The I/F unit 1009 is an interface to transmit the image data output from the image processing unit 1005 to the outside. For example, a universal serial bus (USB) can be applied as the I/F unit 1009. The above is not a limitation, and the I/F unit 1009 may be an interface connectable to a network by wired communication or wireless communication.

The input device 1012 includes an operator to receive a user input. When the electronic device 1000 is, for example, the digital still camera, the digital video camera, or the mobile phone or smartphone with an imaging function, the input device 1012 can include a shutter button to instruct imaging by the image sensor 1004 or an operator to realize the function of the shutter button.

The control unit 1003 includes, for example, a processor such as a central processing unit (CPU), a read only memory (ROM), and a random access memory (RAM), and controls an entire operation of the electronic device 1000 by using the RAM as a work memory according to a program stored in the ROM in advance. For example, the control unit 1003 can control the operation of the electronic device 1000 according to the user input received by the input device 1012. Furthermore, the control unit 1003 can control the autofocus mechanism in the optical system 1002 on the basis of an image processing result of the image processing unit 1005.

### 2-2. Configuration According to the First Embodiment

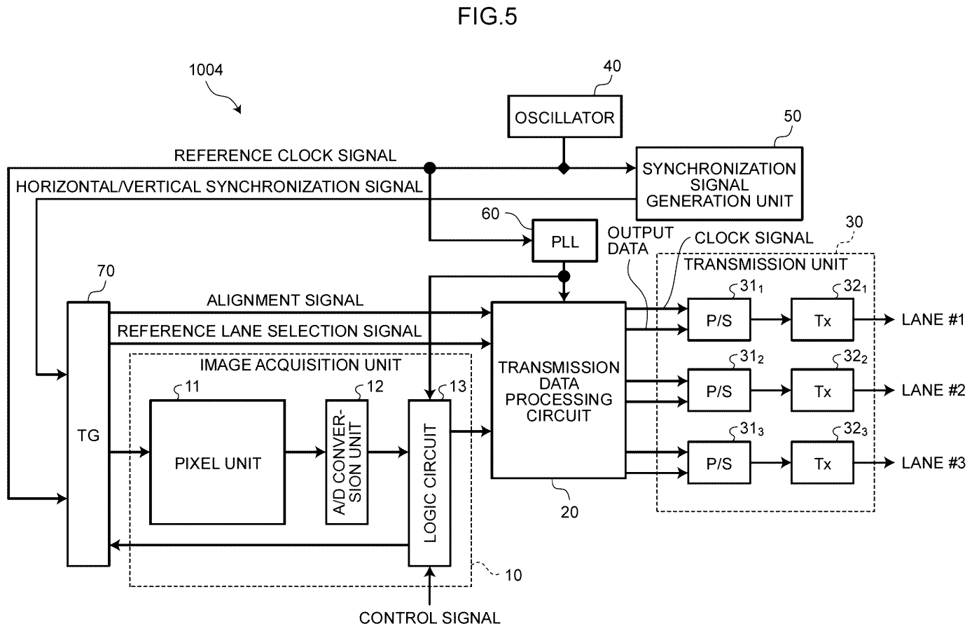

FIG. 5 is a block diagram illustrating an exemplary configuration of the image sensor 1004 applicable to a first embodiment.

In FIG. 5, the image sensor 1004 includes an image acquisition unit 10, a transmission data processing circuit 20, a transmission unit 30, an oscillator 40, a synchronization signal generation unit 50, a phase locked loop (PLL) 60, and a timing generator (TG) 70.

The image acquisition unit 10 includes a pixel unit 11, an A/D conversion unit 12, and a logic circuit 13. The pixel unit 11 includes a pixel array in which pixels that output electric signals corresponding to incident light by photoelectric conversion are arrayed in a lattice shape, and a vertical scanning circuit and a horizontal scanning circuit that drive the pixels of the pixel array. The pixel unit 11 outputs an image signal of an analog signal which image signal is based on an electric signal output from each pixel according to the incident light.

A pixel signal output from the pixel unit 11 is converted into a digital pixel signal by the A/D conversion unit 12. The digital pixel signal converted from the pixel signal by the A/D conversion unit 12 is supplied to the logic circuit 13.

The logic circuit 13 performs predetermined code conversion on the supplied digital pixel signal and generates pixel data. Furthermore, the logic circuit 13 adds predetermined information to the pixel data in units of frames, and generates image data in units of frames. Note that each of the frames includes, for example, pixel data of pixels in an effective pixel region in the pixel array of the pixel unit 11. The logic circuit 13 supplies the generated image data in units of frames to the transmission data processing circuit 20.

The logic circuit 13 is further supplied with a control signal from a higher configuration such as the control unit 1003. The logic circuit 13 generates a transfer control signal related to a transfer of the image data on the basis of the control signal, a PLL clock signal supplied from the PLL 60 (described later), and the digital pixel signal supplied from the A/D conversion unit 12.

For example, the control signal supplied from the higher configuration may include a lane selection signal to select a reference lane among a plurality of lanes to which the image data is transmitted in parallel. Furthermore, the control signal may further include a transmission start instruction signal that instructs a start of a transfer of data to the designated lane. The logic circuit 13 generates a transfer control signal including the lane selection signal and the transmission start instruction signal. The logic circuit 13 supplies the generated transfer control signal to the TG 70.

Note that the logic circuit 13 generates alignment data indicating a start of data transmission in response to the instruction to start the data transfer, and adds the alignment data to a head of the image data to be transmitted. The logic circuit 13 supplies the image data to which the alignment data is added to the transmission data processing circuit 20. Details of the alignment data will be described later.

In FIG. 5, the oscillator 40 generates a reference clock signal serving as a reference of an operation of the image sensor 1004. The reference clock signal is supplied to the synchronization signal generation unit 50, the PLL 60, and the TG 70. The synchronization signal generation unit 50 generates a horizontal synchronization signal and a vertical synchronization signal for driving the pixel array in the pixel unit 11 on the basis of a reference clock. The synchronization signal generation unit 50 supplies the generated horizontal synchronization signal and vertical synchronization signal to the TG 70.

The PLL 60 performs phase synchronization processing on the basis of the reference clock signal supplied from the oscillator 40, and generates a PLL clock signal. The PLL 60 supplies the generated PLL clock signal to the logic circuit 13 and the transmission data processing circuit 20.

The TG 70 supplies the horizontal synchronization signal and the vertical synchronization signal received from the synchronization signal generation unit 50 to the pixel unit 11. The pixel unit 11 drives each pixel of the pixel array unit by the horizontal scanning circuit and the vertical scanning circuit on the basis of the horizontal synchronization signal and the vertical synchronization signal.

The TG 70 generates a reference lane selection signal and an alignment signal on the basis of the reference clock signal supplied from the oscillator 40 and the transfer control signal supplied from the logic circuit 13. The TG 70 supplies the generated reference lane selection signal and alignment signal to the transmission data processing circuit 20.

For example, on the basis of the lane selection signal included in the transfer control signal, the TG 70 generates the reference lane selection signal for selecting, from a plurality of lanes, a reference lane to first perform transmission of data.

As an example, the reference lane selection signal may be a signal having a bit length corresponding to the number of lanes, and may be a 3-bit signal in which each bit indicates a lane when the number of lanes is three. For example, in the reference lane selection signal, a first bit from a least significant bit (LSB) may indicate the lane #1, a second bit may indicate the lane #2, a third bit may indicate the lane #3, and it may be indicated that a lane is the reference lane when a value of the bit is “1”.

For example, the TG 70 generates the alignment signal to be a trigger for starting synchronization in the designated lane on the basis of the transmission start instruction signal included in the transfer control signal and the above-described lane selection signal. The alignment signal may be, for example, a signal a state of which changes at timing of starting the data transmission in the designated lane, and specifically may be a signal a value of which changes from a low state to a high state or from “0” to “1” at the start timing.

Similarly to the reference lane selection signal described above, the alignment signal may be a signal having a bit length corresponding to the number of lanes, and may be a 3-bit signal in which each bit indicates a lane when the number of lanes is three. The alignment signal is not limited to the above, and may be a signal supplied for each lane. Hereinafter, the alignment signals corresponding to the lanes #1, #2, and #3 will be respectively described as alignment signals #1, #2, and #3.

The transmission data processing circuit 20 outputs output data based on the image data supplied from the logic circuit 13 and a clock signal based on the PLL clock signal supplied from the PLL 60 which output data and clock signal correspond to each of the plurality of lanes corresponding to the number of lanes to which the transmission unit 30 performs the data transmission. In the example of FIG. 5, the transmission data processing circuit 20 outputs the output data and the clock signal corresponding to each of the three lanes #1, #2, and #3. The number of lanes from which the transmission data processing circuit 20 outputs the output data and the clock signal is not limited to 3, and may be, for example, two lanes of the lanes #1 and #2 or four or more lanes.

Hereinafter, unless otherwise specified, a signal corresponding to an arbitrary lane will be described as a signal of the lane.

The transmission unit 30 includes a plurality of parallel-serial conversion circuits (described as P/S in the drawing) respectively corresponding to the plurality of lanes, and a plurality of transmission circuits (described as Tx in the drawing). In the example of FIG. 5, the transmission unit 30 includes parallel-serial conversion circuits 31₁, 31₂, and 31₃ and transmission circuits 32₁, 32₂, and 32₃ respectively corresponding to the lanes #1, #2, and #3.

For example, from the transmission data processing circuit 20, the parallel-serial conversion circuit 31₁ is supplied with a clock signal (first clock signal) and output data of the lane #1 (first output data) which data is output as a parallel signal. The parallel-serial conversion circuit 31₁ converts the first output data into a serial signal on the basis of the first clock signal, and supplies the serial signal to the transmission circuit 321. The transmission circuit 32₁ generates transmission data on the basis of the signal supplied from the parallel-serial conversion circuit 31₁ and transmits the generated transmission data to the lane #1.

The same applies to the parallel-serial conversion circuits 31₂ and 31₃ and the transmission circuits 32₂ and 32₃. That is, the parallel-serial conversion circuits 31₂ and 31₃ respectively convert second and third output data supplied from the transmission data processing circuit 20 into serial signals on the basis of second and third clock signals, and respectively supply the serial signals to the transmission circuits 32₂ and 32₃. The transmission circuits 32₂ and 32₃ respectively generate transmission data on the basis of the signals supplied from the parallel-serial conversion circuits 31₂ and 31₃, and respectively transmit the generated transmission data to the lanes #2 and #3.

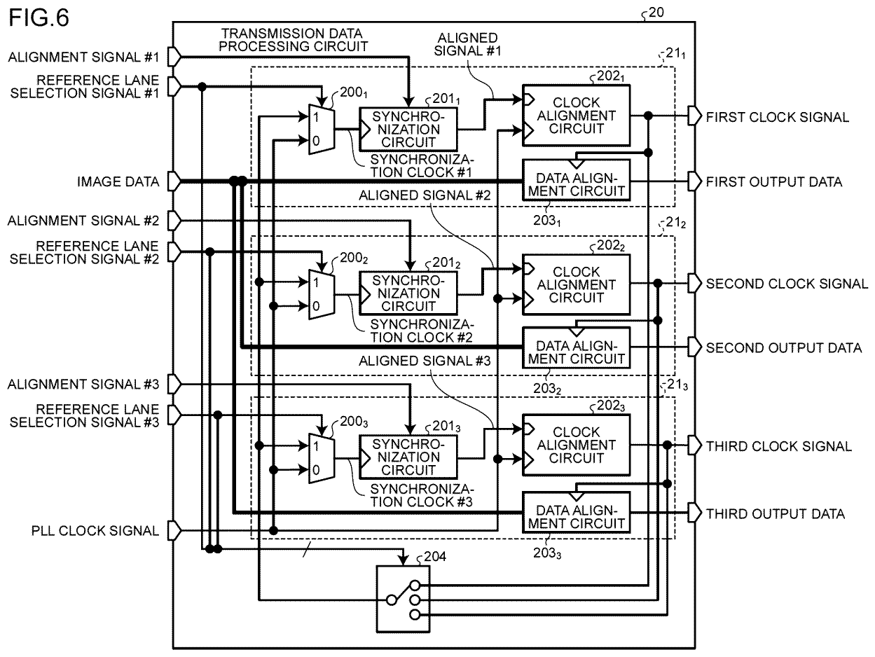

FIG. 6 is a block diagram illustrating an exemplary configuration of the transmission data processing circuit 20 according to the first embodiment.

In FIG. 6, the transmission data processing circuit 20 includes the signal processing circuits 21₁, 21₂, and 21₃ the number of which corresponds to the number of lanes (three in the example of FIG. 6), and one selector 204.

The image data to be transmitted is input to each of the signal processing circuits 21₁, 21₂, and 21₃. In addition, a reference lane selection signal #1 and the alignment signal #1 are input to the signal processing circuit 21₁, and the signal processing circuit 21₁ outputs the first clock signal and the first output data corresponding to the input image data. Similarly, the reference lane selection signals #2 and #3 and the alignment signals #2 and #3 are respectively input to the signal processing circuits 21₂ and 21₃, and the second clock signal and the second output data, and the third clock signal and the third output data are respectively output.

The selector 204 selects one of the first, second, and third clock signals output from the signal processing circuits 21₁, 21₂, and 21₃ according to the reference lane selection signals #1, #2, and #3 supplied from the TG 70 according to each of the lanes, and supplies the selected clock signal to each of the signal processing circuits 21₁, 21₂, and 21₃.

The signal processing circuits 21₁, 21₂, and 21₃ include selectors 200₁, 200₂, and 200₃, synchronization circuits 201₁, 201₂, and 201₃, clock alignment circuits 202₁, 202₂, and 202₃, and data alignment circuits 203₁, 203₂, and 203₃, respectively.

Since the signal processing circuits 21₁ to 21₃ have a common configuration, the signal processing circuit 21₁ will be described here as an example.

In the selector 200₁, a clock signal selected by the selector 204 among the first to third clock signals is input to a first input terminal, and the PLL clock signal is input to a second input terminal. In the selector 200₁, one of the first input terminal or the second input terminal is selected according to the value of the reference lane selection signal #1 supplied from the TG 70. For example, the selector 200₁ selects the first input terminal when the value of the first bit of the reference lane selection signal is “1”, and selects the second input terminal when the value is “0”.

The selector 200₁ outputs, as a synchronization clock signal #1, the clock signal selected from the clock signals input to the first input terminal and the second input terminal, and supplies the signal to the synchronization circuit 201₁. The alignment signal #1 is further input to the synchronization circuit 201₁. The synchronization circuit 201₁ outputs the input alignment signal #1 in synchronization with the clock signal supplied from the selector 200₁.

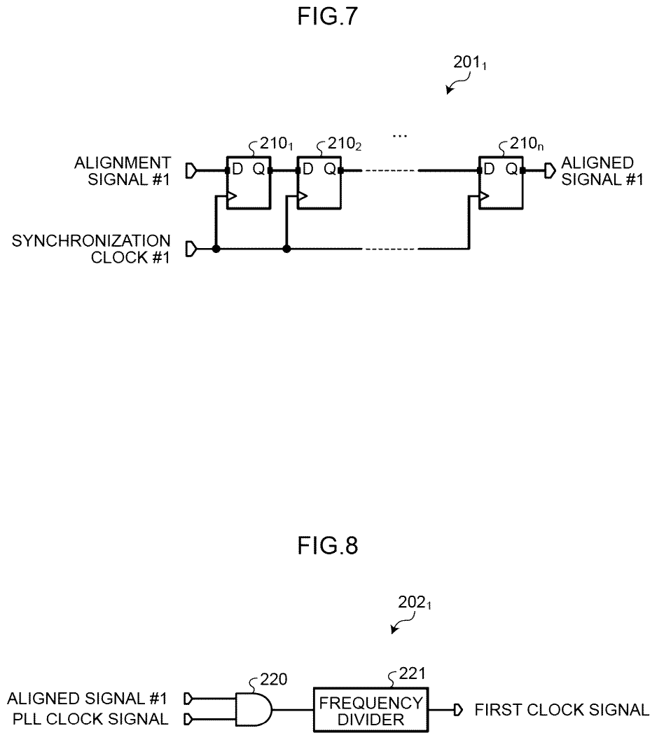

FIG. 7 is a block diagram illustrating an exemplary configuration of the synchronization circuit 201₁ applicable to the first embodiment. As illustrated, the synchronization circuit 201₁ may include a plurality of flip-flop (FF) circuits 210₁, 210₂, . . . , and 210ₙ connected in series. A synchronization clock #1 supplied from the selector 200₁ is input to a clock input terminal of each of the FF circuits 210₁, 210₂, . . . , and 210ₙ.

The alignment signal #1 is input to a data input terminal D of the FF circuit 210₁ that is at the head among the FF circuits 210₁, 210₂, . . . , and 210ₙ, and the alignment signal #1 synchronized by the synchronization clock #1 is output from a data output terminal Q. An output of the FF circuit 210₁ is input to a data input terminal D of the FF circuit 210₂ of the next stage. Then, the outputs of the respective FF circuits are sequentially transmitted and an aligned signal #1 is output from the FF circuit 210ₙ at the last stage.

In the synchronization circuits 201₁ to 201ₙ, the number of stages of the FF circuits 210₁ to 210ₙ is preferably determined in consideration of the number of stages in which a metastable state is not generated.

Returning to the description of FIG. 6, the aligned signal #1 output from the synchronization circuit 201₁ is input to the clock alignment circuit 202₁. The clock alignment circuit 202₁ further receives the PLL clock signal.

The clock alignment circuit 202₁ sets validity and invalidity of the PLL clock signal according to the aligned signal #1. FIG. 8 is a block diagram illustrating an exemplary configuration of the clock alignment circuit 202₁ applicable to the first embodiment. As illustrated, the clock alignment circuit 202₁ includes an AND circuit 220 and a frequency divider 221.

In the AND circuit 220, the aligned signal #1 is input to a first input terminal, and the PLL clock signal is input to a second input terminal. As described above, the aligned signal #1 is a signal acquired by synchronization of the alignment signal #1 a state of which changes at the timing of starting the data transmission in the lane #1 with the synchronization clock #1, and a value thereof changes, for example, from “0” to “1” according to the timing. The PLL clock signal input to the AND circuit 220 is validated in a period in which the aligned signal #1 has the value “1”, and is output from the AND circuit 220.

The PLL clock signal output from the AND circuit 220 is frequency-divided at a predetermined frequency division ratio in the frequency divider 221 and is output as the first clock signal.

Returning to the description of FIG. 6, the first clock signal output from the clock alignment circuit 2021 is supplied from the transmission data processing circuit 20 to the transmission unit 30, and is also supplied to the data alignment circuit 203₁ and the selector 204.

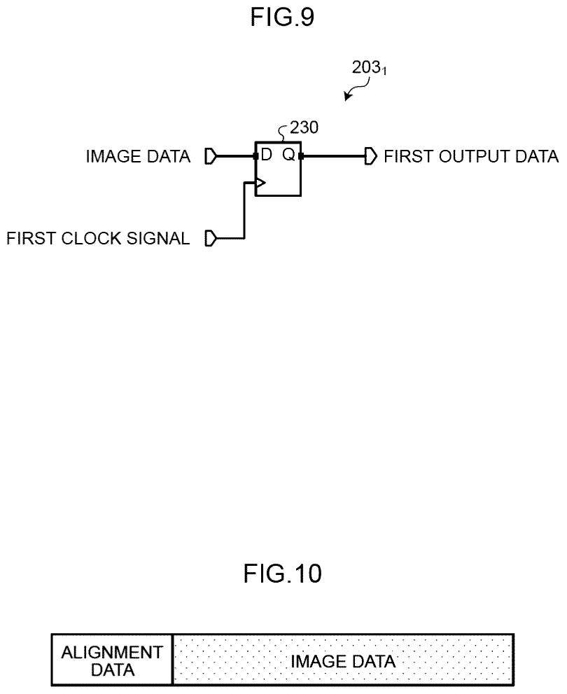

The data alignment circuit 203₁ receives an input of image data, synchronizes the input image data with the first clock signal, and outputs the image data as first output data. FIG. 9 is a block diagram illustrating an exemplary configuration of the data alignment circuit 203₁ applicable to the first embodiment. As illustrated, the data alignment circuit 203₁ includes an FF circuit 230.

In the FF circuit 230, the image data is input to a data input terminal D, and the first clock signal is input to a clock input terminal. The FF circuit 230 synchronizes the image data input to the data input terminal D with the first clock signal input to the clock input terminal, and outputs the image data as the first output data. The first output data is supplied from the transmission data processing circuit 20 to the transmission unit 30.

FIG. 10 is a schematic diagram illustrating an exemplary data structure of the output data applicable to the first embodiment. In FIG. 10, the output data has a structure in which, for example, the alignment data as identification information is arranged at the head of the image data. The alignment data only needs to be a unique pattern, and a bit width and the number of symbols may be arbitrarily determined. As described above, the alignment data is generated and added in the logic circuit 13 according to the instruction to start the data transfer. Furthermore, the image data may be, for example, data in which frame identification information for identifying a frame or line identification information for identifying each line is arranged at a predetermined position with respect to a data string of the pixel data.

Note that the selectors 200₂ and 200₃, the synchronization circuits 201₂ and 201₃, the clock alignment circuits 202₂ and 202₃, and the data alignment circuits 203₂ and 203₃ respectively have configurations similar to those of the selector 200₁, the synchronization circuit 201₁, the clock alignment circuit 202₁, and the data alignment circuit 203₁ described above, and thus, description thereof is omitted here.

As described above, each of the signal processing circuits 21₁, 21₂, and 21₃ according to the first embodiment. functions as a signal processing unit that outputs the output clock signal and the output data based on the input data, which output data is synchronized with the output clock signal, to the corresponding lane among the plurality of lanes. Furthermore, the selector 204 functions as a first selection circuit that selects an output clock signal corresponding to the reference lane among the output clock signals, which are respectively output from the plurality of signal processing units, according to the reference lane selection signal for selecting the reference lane from the plurality of lanes, and that outputs the selected output clock signal to each of the plurality of signal processing units.

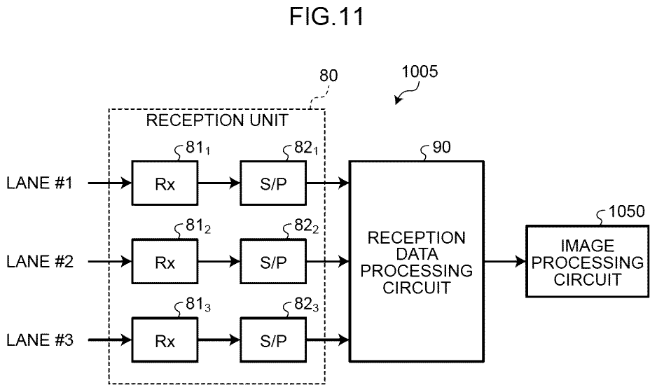

FIG. 11 is a block diagram illustrating an exemplary configuration of the image processing unit 1005 applicable to the first embodiment. In FIG. 11, the image processing unit 1005 includes a reception unit 80, a reception data processing circuit 90, and an image processing circuit 1050.

The reception unit 80 includes a reception circuit (described as Rx in the drawing) corresponding to each of the plurality of lanes, and a plurality of serial-parallel conversion circuits (described as S/P in the drawing). In the example of FIG. 11, the reception unit 80 includes reception circuits 81₁, 81₂, and 81₃ and serial-parallel conversion circuits 82₁, 82₂, and 82₃ respectively Corresponding to the lanes #1, #2, and #3.

For example, the reception circuit 81₁ identifies the alignment data from the data received from the lane #1, detects the head of the image data, and extracts the image data. The image data extracted by the reception circuit 81₁ is converted into image data of a parallel signal by the serial-parallel conversion circuit 82₁ and supplied to the reception data processing circuit 90.

The same applies to the reception circuits 81₂ and 81₃ and the serial-parallel conversion circuits 82₂ and 82₃. That is, the reception circuits 81₂ and 81₃ identify the alignment data from the signals received from the lanes #2 and #3, detect the head of the image data, and extract the image data, respectively. The reception circuits 81₂ and 81₃ supply the extracted image data to the serial-parallel conversion circuits 82₂ and 82₃, respectively. Each of the serial-parallel conversion circuits 82₂ and 82₃ converts the supplied image data into a parallel signal and supplies the parallel signal to the reception data processing circuit 90.

The reception data processing circuit 90 performs predetermined processing on the image data of each of the lanes #1, #2, and #3 supplied from the reception unit 80, and supplies the processed image data to the image processing circuit 1050. For example, the reception data processing circuit 90 may reconstruct a frame image on the basis of the supplied image data. The image processing circuit 1050 may be, for example, a digital signal processor (DSP), and performs predetermined image processing on the supplied image data and performs an output thereof.

### 2-3. Processing According to the First Embodiment

Next, the processing according to the first embodiment will be described in more detail.

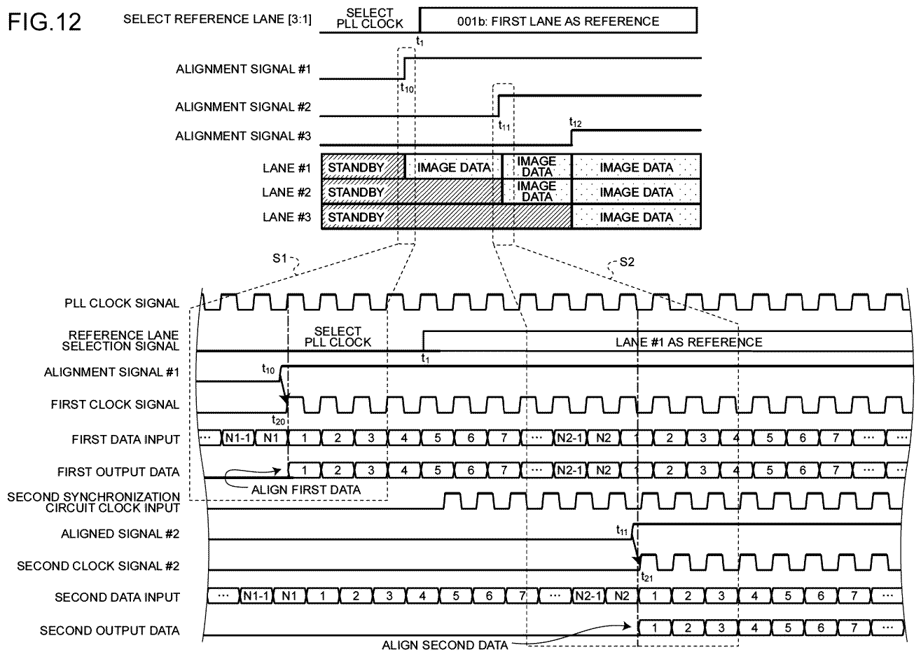

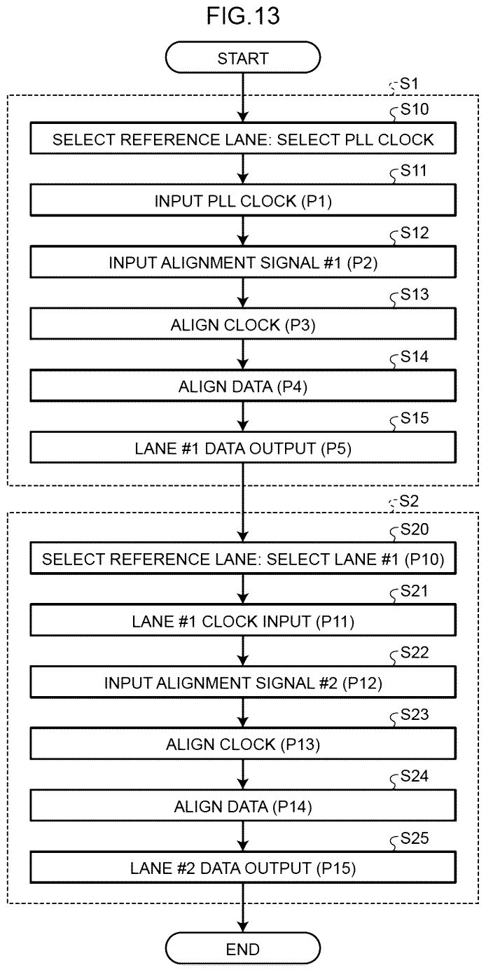

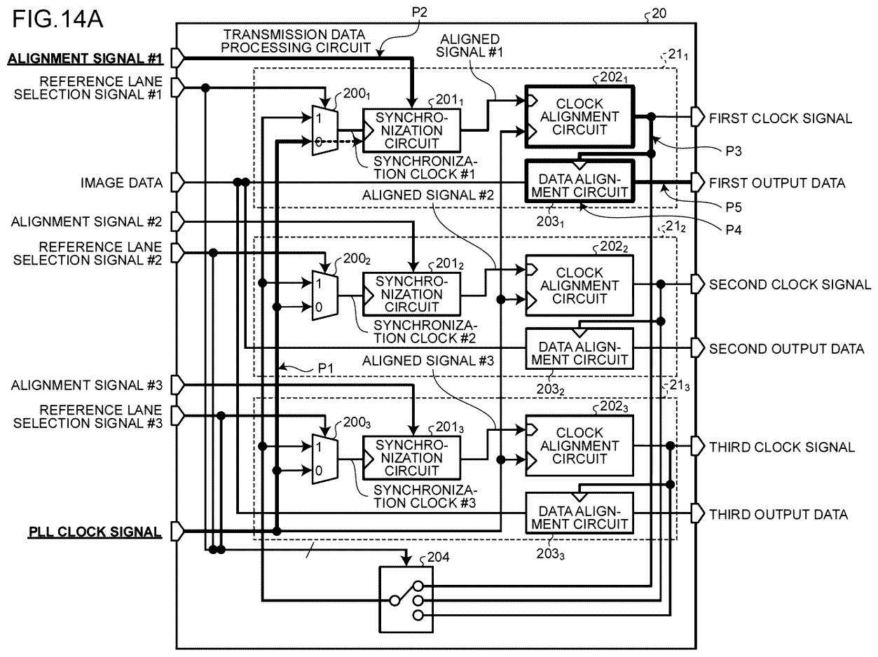

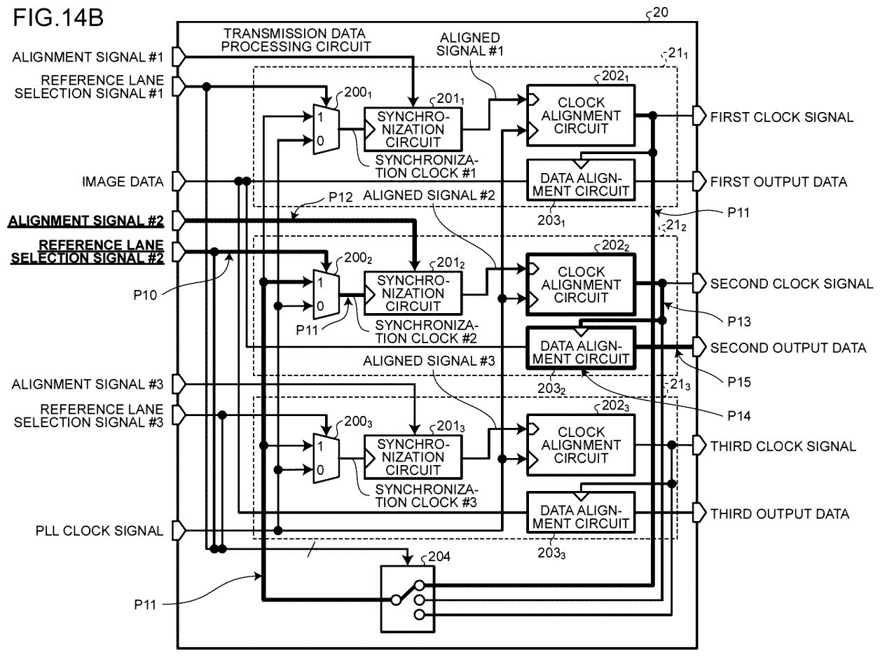

FIG. 12 is a time chart illustrating exemplary processing in the transmission data processing circuit 20 according to the first embodiment. In addition, FIG. 13 is a flowchart illustrating exemplary processing in the transmission data processing circuit 20 according to the first embodiment. Furthermore, FIG. 14A and FIG. 14B are respectively schematic diagrams illustrating flows of signals in Step S1 and Step S2 of the flowchart in FIG. 13.

Note that FIG. 12 and FIG. 13, and FIGS. 14A and 14B are views illustrating an example of a case where the lane #1 is selected as the reference lane and the image data is transmitted, and then transmission of the image data is started in the lane #2.

In FIG. 12, for example, an upper part illustrates an example of the reference lane selection signal supplied from the TG 70 to the transmission data processing circuit 20 in accordance with the control signal from the higher configuration (such as the control unit 1003) of the image sensor 1004, the alignment signals #1, #2, and #3, and the image data transmitted from the image sensor 1004 to the lanes #1, #2, and #3. Note that the alignment data arranged at the head of the image data is omitted here.

In the example of FIG. 12, the reference lane selection signal is a 3-bit signal in which the bits respectively correspond to the lanes #1, #2, and #3, and the value of each of the 3 bits is “0” in an initial state. Thus, in the initial state, the second input terminal is selected in each of the selectors 200₁, 200₂, and 200₃, and the PLL clock signal is input to each of the synchronization circuits 201₁, 201₂, and 201₃ via the selectors 200₁, 200₂, and 200₃, respectively.

In this case, until immediately before time t₁₀, the alignment signals #1, #2, and #3 are set to the value “0” (low state), and accordingly, the aligned signals #1, #2, and #3 are set to the value “0” (low state). Thus, the first clock signal, the second clock signal, and the third clock signal are not output in the clock alignment circuits 202₁, 202₂, and 202₃, respectively. Thus, until time t₁₀, t₁₁, and t₁₂ when the values of the alignment signals #1, #2, and #3 become “1” (high state), each of the lane #1, the lane #2, and the lane #3 is in the standby state.

At the time t₁₀, t₁₁, and t₁₂, in the lanes #1, #2, and #3, the values of the corresponding alignment signals #1, #2, and #3 are set to “1” (high state), and accordingly, the aligned signals #1, #2, and #3 are set to the value “1”. The first clock signal, the second clock signal, and the third clock signal are respectively output from the clock alignment circuits 202₁, 202₂, and 202₃ in response to the timing at which the value of each of the aligned signals #1, #2, and #3 becomes “1”. As a result, the output of the image data to the lanes #1, #2, and #3 is started.

In FIG. 12, in a lower part, the PLL clock signal, the reference lane selection signal, the alignment signal #1, the first clock signal, a first data input, a first data output, a second synchronization circuit clock input, the aligned signal #2, the second clock signal, a second data input, and a second output data are illustrated from the top.

Among the above, the first data input and the second data input indicate inputs of the image data to the signal processing circuits 21₁ and 21₂ (data alignment circuits 203₁ and 203₂), respectively. In addition, the second synchronization circuit clock input indicates a synchronization clock #2 input to the synchronization circuit 201₂.

Processing in the transmission data processing circuit 20 will be described with reference to the flowchart in FIG. 13. In the flowchart of FIG. 13, processing related to the reference lane (lane #1) is performed in Step S1, and processing related to the lane #2 in which the data transmission is started next to the reference lane is performed in Step S2.

First, the processing in Step S1 will be described with reference to FIG. 14A. In the reference lane selection signals #1, #2, and #3, the value of each bit is “0” (low state) in the initial state.

In Step S1, in first Step S10, in the transmission data processing circuit 20, the second input terminal is selected in each of the selectors 200₁, 200₂, and 200₃ according to the reference lane selection signal #1, and the PLL clock signal is selected as each of the synchronization clocks #1, #2, and #3. Next, in Step S11, the transmission data processing circuit 20 inputs the PLL clock signal to the synchronization circuit 201₁ as the synchronization clock signal #1 via the selector 200₁ according to the selection by the selector 200₁ (P1 in FIG. 14A).

Next, in Step S12, for example, at the time t₁₀, the state of the alignment signal #1 changes from the low state to the high state (or from the value “0” to “1”), and the alignment signal #1 is input to the synchronization circuit 201₁ (P2 in FIG. 14A). The transmission data processing circuit 20 causes the synchronization circuit 201₁ to synchronize a rise of the alignment signal #1 at the time t₁₀ with the PLL clock signal at time t₂₀, and generates the aligned signal #1 (not illustrated).

The transmission data processing circuit 20 inputs the generated aligned signal #1 to the clock alignment circuit 202₁. In Step S13, the transmission data processing circuit 20 makes the PLL clock signal valid according to the input aligned signal #1 by the clock alignment circuit 202₁, and outputs the first clock signal from the time t₂₀ (P3 in FIG. 14A). The first clock signal is supplied to the transmission unit 30, and is also supplied to the data alignment circuit 203₁ and the selector 204.

In the next Step S14, the transmission data processing circuit 20 synchronizes the image data input by the first data input with the first clock signal by the data alignment circuit 203₁, and performs data alignment processing on the image data (P4 in FIG. 14A). In the next Step S15, the transmission data processing circuit 20 outputs the image data input as the first input data and synchronized with the first clock signal as the first output data by the data alignment circuit 203₁ (P5 in FIG. 14A).

The first output data is aligned at the time to at which the rising timing of the aligned signal #1 (not illustrated) corresponding to the alignment signal #1 at the time t₁₀ is synchronized by the PLL clock signal.

Next, processing in Step S2 will be described with reference to FIG. 14B.

In Step S2, in first Step S20, the transmission data processing circuit 20 selects the lane #1 as the reference lane according to the reference lane selection signal #2 (P10 in FIG. 14B), the first input terminal is selected in the selector 200₂, and the first clock signal is selected as the synchronization clock #2. Next, in Step S21, the transmission data processing circuit 20 inputs the first clock signal to the synchronization circuit 201₂ as the synchronization clock signal #2 via the selector 200₂ according to the selection by the selector 200₂ (P11 FIG. 14B).

In next Step S22, the transmission data processing circuit 20 inputs the alignment signal #2 in which the value of the alignment signal #2 is changed from “0” to “1” at the time t₁₁ to the synchronization circuit 201₂ (P12 in FIG. 14B). The transmission data processing circuit 20 synchronizes a rise of the alignment signal #2 at the time t₁₁ with the first clock signal by the synchronization circuit 201₂, and generates the aligned signal #2 (not illustrated). The transmission data processing circuit 20 inputs the generated aligned signal #2 to the clock alignment circuit 202₂.

In Step S23, the transmission data processing circuit 20 makes the PLL clock signal valid according to the input aligned signal #2 by the clock alignment circuit 202₂, and outputs the second clock signal from the time t₂₁ (P13 in FIG. 14B). The second clock signal is supplied to the transmission unit 30, and is also supplied to the data alignment circuit 203₂ and the selector 204.

In next Step S24, the transmission data processing circuit 20 synchronizes the image data input by the second data input with the second clock signal by the data alignment circuit 203₂, and performs the data alignment processing on the image data (P14 in FIG. 14B). In next Step S25, the transmission data processing circuit 20 outputs, as the second output data, the image data synchronized with the second clock signal by the data alignment circuit 203₂ (P15 in FIG. 14B).

The second output data is aligned at the time t₂₁ at which the rising timing of the aligned signal #2 corresponding to the alignment signal #2 (not illustrated) at the time t₁₁ is synchronized by the first clock signal.

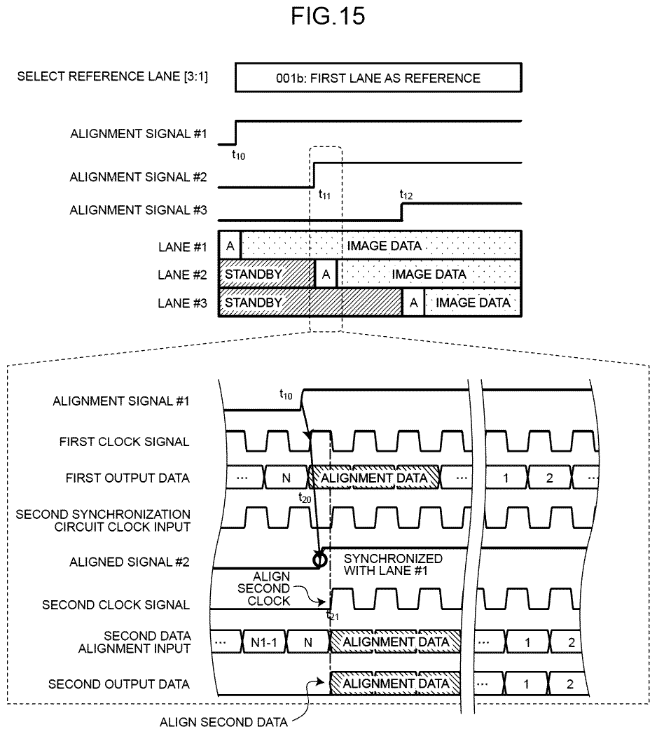

FIG. 15 is a time chart of an example illustrating transmission processing according to the first embodiment.

In the example of FIG. 15, it is assumed that the lane #1 is selected as the reference lane. In FIG. 15, a vicinity of the time t₁₁ in the upper part of FIG. 12 is selected and illustrated in an upper part, and a portion corresponding to the upper part of FIG. 15 in the lower part of FIG. 12 is selected and illustrated in a lower part. The lower part of FIG. 15 partially corresponds to the lower part of FIG. 12, and the alignment signal #1, the first clock signal, the first output data, the second synchronization circuit clock input, the aligned signal #2, the second clock signal, a second data alignment input, and the second output data are illustrated from the top. In addition, the second data alignment input indicates the aligned signal #2 input to the clock alignment circuit 202₂.

Note that, in FIG. 15, the alignment signal #1, the first clock signal, and the first output data are illustrated in the vicinity of the time t₁₁ for the sake of description.

For example, the transmission circuit 32₁ corresponding to the lane #1 transmits, as the transmission data, the first output data including the image data and the alignment data arranged at the head of the image data at the time t₂₀ corresponding to the rise of the alignment signal #1 at the time t₁₀.

Similarly, the transmission circuit 32₂ corresponding to the lane #2 transmits, as the transmission data, the second output data including the image data and the alignment data arranged at the head of the image data at the time t₂₁ at which the aligned signal #2 based on the alignment signal #2 at the time t₁₁ (not illustrated) is aligned by the first clock signal. In the example of FIG. 15, the alignment data has a length of three clocks of each of the first clock signal and the second clock signal.

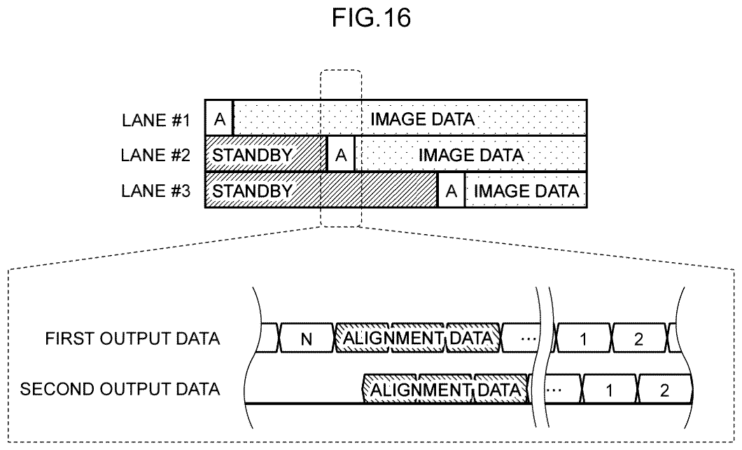

FIG. 16 is a time chart of an example illustrating reception processing according to the first embodiment. In FIG. 16, the first output data and the second output data transmitted as the transmission data by each of the lanes #1, #2, and #3 are illustrated in an upper part. As described above, the alignment data as the identification information is added to the head of each piece of the output data transmitted as the transmission data to each of the lanes #1, #2, and #3.

In FIG. 16, for the sake of description, timing of the transmission of the alignment data in the first £ output data and timing of the transmission of the alignment data in the second output data are illustrated to be close to each other.

For example, the reception circuit 81₁ receives the first output data transmitted as the transmission data from the transmission unit 30 to the lane #1, and supplies the received first output data to the serial-parallel conversion circuit 82₁. The serial-parallel conversion circuit 82₁ converts the supplied first output data into a parallel signal and supplies the parallel signal to the reception data processing circuit 90.

The same applies to the lanes #2 and #3. That is, the reception circuits 812 and 813 respectively receive the second output data and the third output data transmitted as transmission data from the transmission unit 30 to the lanes #2 and #3, and respectively supply the received second output data and third output data to the serial-parallel conversion circuits 82₂ and 82₃. The serial-parallel conversion circuits 82₂ and 82₃ respectively convert the supplied second output data and third output data into parallel signals, and supply the parallel signals to the reception data processing circuit 90.

The reception data processing circuit 90 identifies the alignment data from the first output data supplied, for example, from the serial-parallel conversion circuit 82₁, and detects the head of the image data. The reception data processing circuit 90 extracts the image data from the received first output data on the basis of a detection result of the head of the image data. Similarly, the reception data processing circuit 90 extracts the image data from each of the received second output data and third output data.

The reception data processing circuit 90 may generate frame image data on the basis of the frame identification information and the line identification information included in the image data extracted from each piece of the output data. The frame image data generated by the reception data processing circuit 90 is supplied to the image processing circuit 1050.

As described above, in the first embodiment, since the data aligned on a transmission side (transmission data processing circuit 20) is transferred, synchronization processing is unnecessary on a reception side. Thus, by applying the configuration according to the first embodiment, it is possible to eliminate processes and redundant data that make it difficult to increase the speed. Thus, the configuration according to the first embodiment is specifically suitable for use in an image sensor that needs to process a large amount of data at high speed.

### Simulation Result of Processing According to the First Embodiment

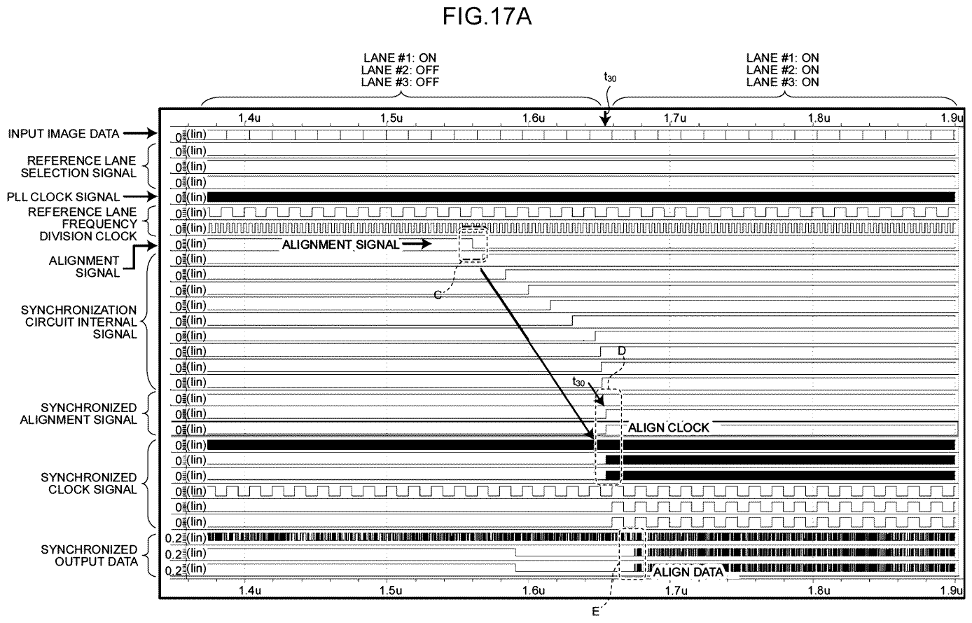

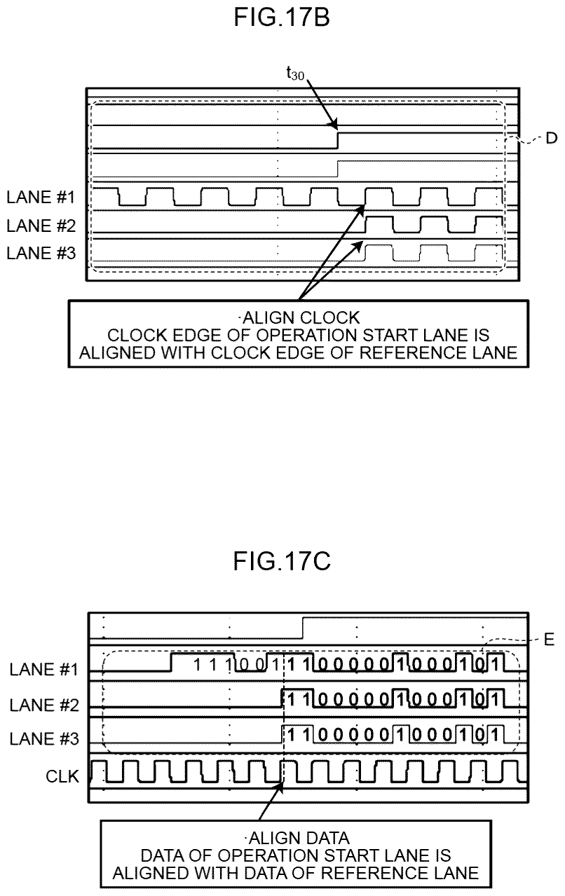

Next, a simulation result of the processing according to the first embodiment described above will be described with reference to FIG. 17A, FIG. 17B, and FIG. 17 C.

Note that an example in which a waveform of each signal is simulated in a case where the lane #1 is set as the reference lane and one-lane driving of the lane #1 is switched to three-lane driving of the lanes #1 to #3 is illustrated in FIG. 17A, FIG. 17B, and 17C. More specifically, a left side of the time t₃₀ in FIG. 17A indicates a state of the one-lane driving in which the lane #1 is on and the lanes #2 and #3 are off. On the other hand, a right side of the time t₃₀ indicates a state in which each of the lanes #1 to #3 is on and switching to the three-lane driving is performed.

In FIG. 17A, the input image data, the reference lane selection signal for three lanes, the PLL clock signal, a reference lane frequency division clock, the alignment signal (alignment signal #1), a synchronization circuit internal signal, the synchronized alignment signal, the synchronized clock signal, and the synchronized output data are illustrated from the top.

Among the above, the alignment signal is the alignment signal #1 input in a manner corresponding to the lane #1, and is an inverted signal in this example. Furthermore, the synchronized alignment signals are signals that correspond to the lanes #2 and #3 and that are synchronized with the first clock signal output in response to the aligned signal #1 that is the alignment signal #1 synchronized on the basis of the PLL clock signal.

The synchronized clock signals indicate input and output clock signals in the clock alignment circuits 202₁, 202₂, and 202₃. More specifically, upper three waveforms among six waveforms of the synchronized clock signals indicate the outputs of the AND circuits 220 in the clock alignment circuits 202₁, 202₂, and 202₃, respectively. That is, the waveforms of the second and third rows from the top indicate signals in which the PLL clock signals input to the clock alignment circuits 202₂ and 202₃ are synchronized by the aligned signals #2 and #3 by the AND circuits 220. In addition, the lower three waveforms indicate the outputs of frequency dividers 221 in the clock alignment circuits 202₁, 202₂, and 202₃, respectively.

The synchronization circuit internal signal indicates, for example, an example of a waveform of an output signal of each of the FF circuits 210₁, 210₂, . . . , and 210ₙ inside the synchronization circuit 2011. In the drawing, portions that look like steps are outputs via the multi-stage FF circuits 210.

In FIG. 17A, an internal signal of the synchronization circuit 201₁ moves with a change in the alignment signal #1 indicated by a frame C as a trigger, and the synchronized alignment signal is generated. With this synchronized alignment signal as a trigger, alignment of the second clock signal and the third clock signal is performed in a portion indicated by a frame D in FIG. 17A.

A state in which the frame D portion of FIG. 17A is enlarged is illustrated in FIG. 17B. In FIG. 17B, the upper three waveforms indicate the alignment signal #1 and the synchronized alignment signals of the lanes #2 and #3. In addition, as described above, the lower three waveforms indicate the outputs of the AND circuits 220 in the clock alignment circuits 202₁, 202₂, and 202₃, respectively. That is, the lower three waveforms are the PLL clock signals, and the waveforms of the second and third rows are the PLL clock signals synchronized by the alignment signals of the lanes #2 and #3.

Frequencies of the PLL clock signals of the lanes #1, #2, and #3 are divided by the frequency dividers 221 respectively in the clock alignment circuits 202₁, 202₂, and 202₃, and the first clock signal corresponding to the lane #1, the second clock signal corresponding to the lane #2, and the third clock signal corresponding to the lane #3 are generated. In FIG. 17B, it can be seen that clock edges of operation start lanes (lanes #2 and #3) in which operations are started at time t₃₀ are aligned with a clock edge of the reference lane (lane #1).

A state in which a frame E portion of FIG. 17A is enlarged is illustrated in FIG. 7C. As illustrated in FIG. 17C, each bit value of each of the operation start lanes (lanes #2 and #3) in which the operations are started at the time t₃₀ matches with each bit value of the first output data of the lane #1 that is the reference lane. That is, it can be seen that the data of the operation start lanes is aligned with the data of the reference lane by the data alignment processing in each of the data alignment circuits 203₂ and 203₃.

### 3. Second Embodiment of the Present Disclosure

Next, the second embodiment of the present disclosure will be described.

### 3-1. Problem of the First Embodiment

In the first embodiment described above, an alignment signal is provided in each lane of the output by the transmission unit 30 that performs the serial transfer, and the other lanes are synchronized on the basis of the clock of the reference lane. Thus, by applying the configuration of the first embodiment, it becomes possible to synchronize the image data to be serially transferred in parallel without using a synchronization code in the data transfer and further without separately providing a synchronization adjustment circuit on the reception side. As a result, it is possible to eliminate a process and redundant data that hinder an increase in speed, to efficiently transfer data by using a plurality of lanes, and to process a large amount of data at high speed.

On the other hand, in the configuration of the first embodiment, in a case where a new lane is added to a lane that is already in the communication state, and switching from the standby state to the communication state is performed, there is a possibility that noise is mixed in the lane that is in the communication state first.

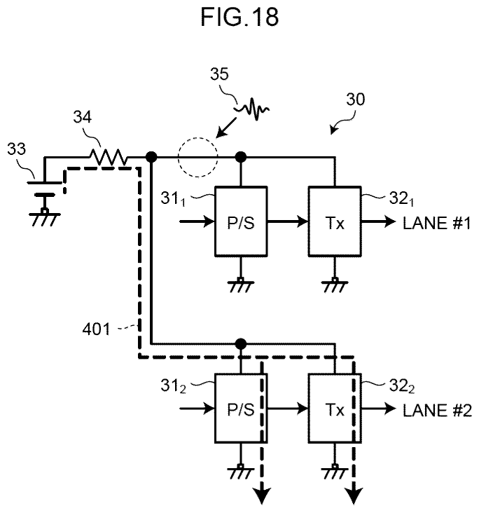

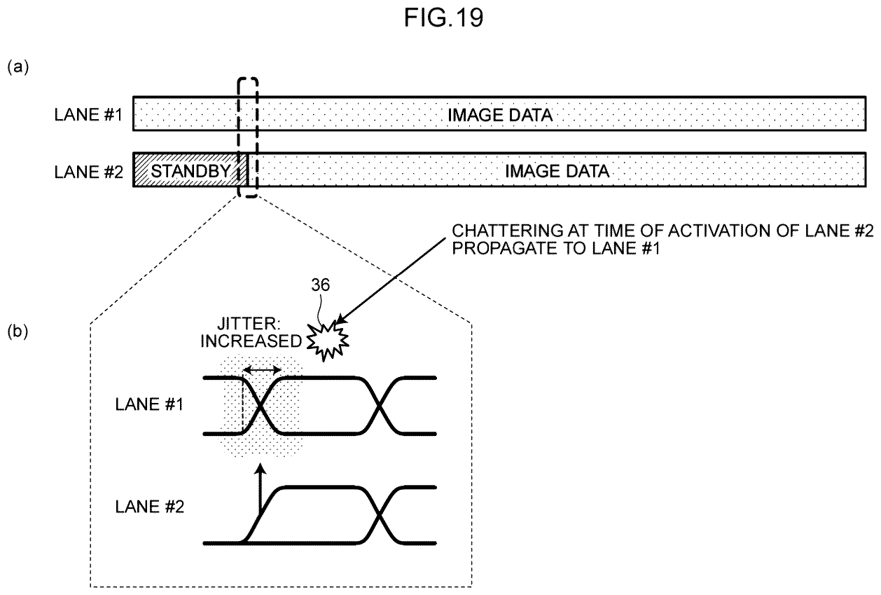

FIG. 18 and FIG. 19 are schematic diagrams for describing noise mixture in a case where a new lane is switched to a communication state in the configuration according to the first embodiment. In an example of FIG. 18, it is assumed that the transmission unit 30 corresponds to two lanes (lane #1 and lane #2) and includes the parallel-serial conversion circuits 31₁ and 31₂ and the transmission circuits 32₁ and 32₂.

In the transmission unit 30, a power supply current is supplied from a power supply 33 to the parallel-serial conversion circuit 31₁ and the transmission circuit 32₁ of the first lane (lane #1) via a power supply line having finite impedance 34. Furthermore, the power supply current from the power supply 33 is branched on the output side of the impedance 34, and is similarly supplied to the parallel-serial conversion circuit 31₂ and the transmission circuit 32₂ of the second lane (lane #2).

In this configuration, as illustrated in a section (a) of FIG. 19, for example, a case where the lane #2 is switched from the standby state to the communication state while the lane #1 is in the communication state will be considered. In this case, a steeply changing current flows into the power supply line connected to the parallel-serial conversion circuit 31₂ and the transmission circuit 32₂ along with a rapid voltage fluctuation at the time of switching. This transient steeply changing current is converted into chattering 35 (see FIG. 18) by the finite impedance 34 existing in the power supply line, and then propagates as a noise 36 to the lane #1 via the power supply line as illustrated in a section (b) of FIG. 19. The noise 36 may deteriorate jitter of the communication signal in the parallel-serial conversion circuit 31₁ and the transmission circuit 32₁, and hinder an increase in speed of communication.

The deterioration of the jitter of the communication signal due to the noise 36 and the hindrance to the increase in the speed of the communication associated therewith become remarkable as communication speed increases. As a result, a speed increase limitation by the noise 36 leads to a decrease in a data transfer amount per unit time, and may reduce data transfer efficiency.

In view of this problem, the second embodiment according to the present disclosure aims to provide a communication device and a communication method that achieve both an improvement in transfer efficiency and an enhancement in noise resistance.

### 3-2. Outline of the Second Embodiment

Next, a configuration and an operation according to the second embodiment of the present disclosure will be schematically described.

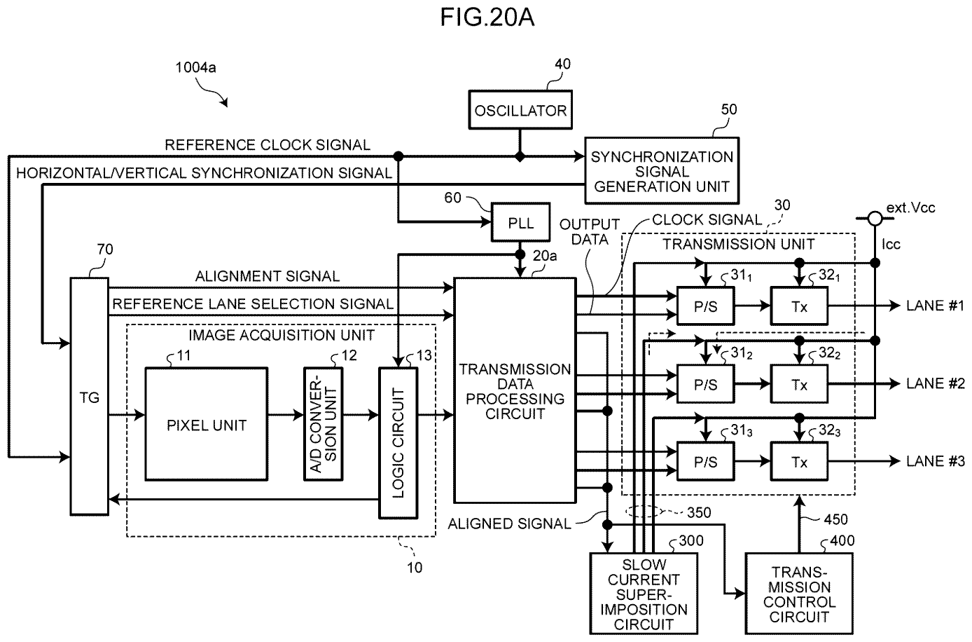

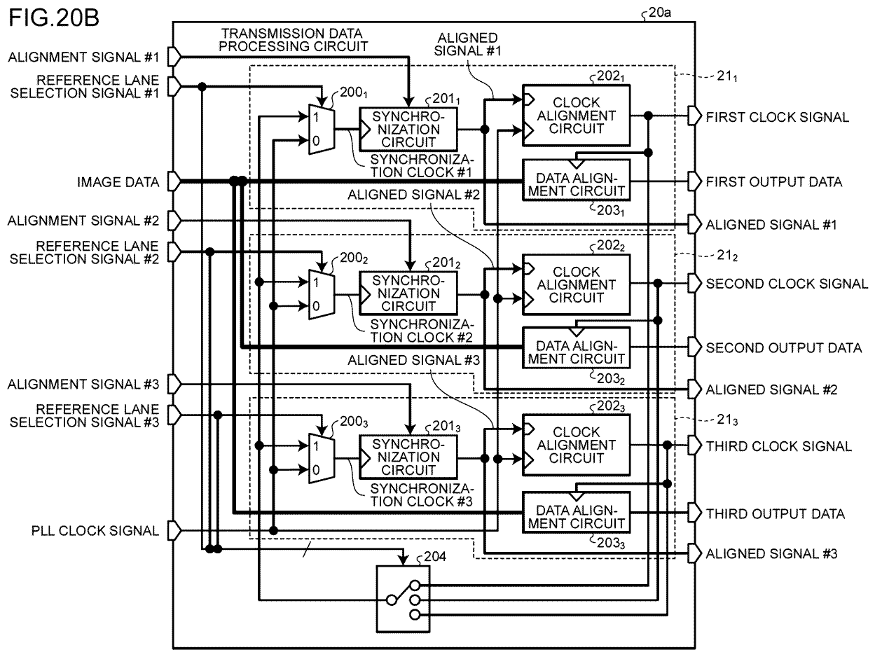

FIG. 20A is a block diagram illustrating an exemplary configuration of an image sensor 1004a according to the second embodiment. In FIG. 20A, the image sensor 1004a has a configuration in which a slow current superimposition circuit 300 and a transmission control circuit 400 are added to the configuration of the image sensor 1004 according to the first embodiment described with reference to FIG. 5.

FIG. 20B is a block diagram illustrating an exemplary configuration of a transmission data processing circuit 20a according to the second embodiment. In FIG. 20B, the transmission data processing circuit 20a is configured to supply aligned signals #1, #2, and #3 to clock alignment circuits 202₁, 202₂, and 202₃ and performs an output thereof from the transmission data processing circuit 20a with respect to the configuration of the transmission data processing circuit 20 according to the first embodiment described with reference to FIG. 6.

Returning to the description of FIG. 20A, the transmission control circuit 400 generates a transmission control signal 450 for controlling a parallel-serial conversion circuit 31₁ and a transmission circuit 32₁, a parallel-serial conversion circuit 31₂ and a transmission circuit 32₂, and a parallel-serial conversion circuit 31₃ and a transmission circuit 32₃ of lanes #1, #2, and #3 on the basis of the aligned signals #1, #2, and #3 output from the transmission data processing circuit 20a.

In addition, the slow current superimposition circuit 300 generates a slow starting/shutdown current 350 for each of the lanes #1, #2, and #3 on the basis of the aligned signals #1, #2, and #3 output from the transmission data processing circuit 20a. The slow starting/shutdown current 350 is a signal for moderating a steep current change before a start and after a cutoff of supply of a power supply Vcc (described as a power supply ext. Vcc in the drawing) to each circuit according to the transmission control signal 450.

The slow current superimposition circuit 300 superimposes the slow starting/shutdown current 350 generated for each of the lanes #1, #2, and #3 on the power supply Vcc supplied to each of the parallel-serial conversion circuit 31₁ and the transmission circuit 32₁, the parallel-serial conversion circuit 31₂ and the transmission circuit 32₂, and the parallel-serial conversion circuit 31₃ and the transmission circuit 32₃ of the lanes #1, #2, and #3.

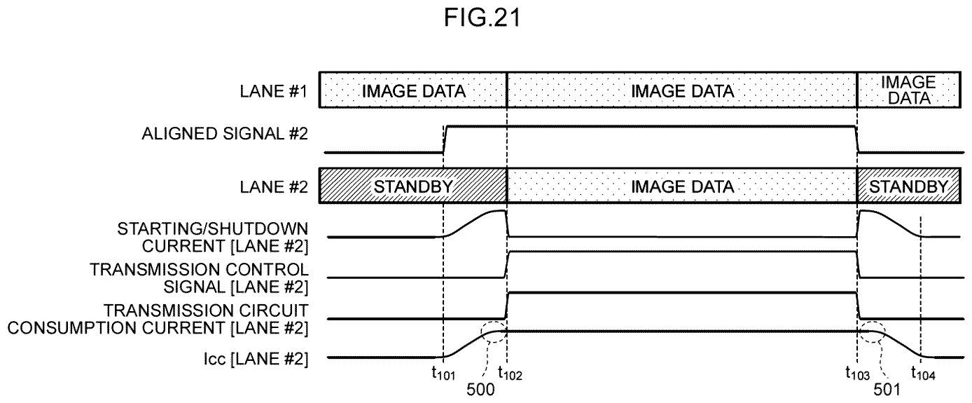

FIG. 21 is a time chart of an example for describing the operation according to the second embodiment. Here, a case where the second lane (lane #2) in the standby state is shifted to the communication state with respect to the first lane (lane #1) in the communication state, and then, is shifted to the standby state again will be considered. Note that it is assumed that the transmission control signal 450 starts an operation of a corresponding circuit in a high state, that is, a value “1”, and stops the operation of the circuit in a low state, that is, a value “0”.

In a period during which the lane #2 is in the standby state, the aligned signal #2 corresponding to the lane #2 switches from the value “0” to the value “1” at time t₁₀₁. The transmission control circuit 400 switches the value of the transmission control signal 450 (described as the transmission control signal (lane #2) in the drawing) corresponding to the lane #2 from “0” to “1” at

time t₁₀₂ after a lapse of a predetermined time from the time t₁₀₁ with reference to the time t₁₀₁ at which the aligned signal #2 is switched to the value “1”.

Operations of the parallel-serial conversion circuit 31₂ and the transmission circuit 32₂ of the lane #2 are started when the transmission control signal 450 of the lane #2 becomes the value “1” at the time t₁₀₂. When the operations of the parallel-serial conversion circuit 31₂ and the transmission circuit 32₂ are started, a consumption current corresponding to an operation current of the circuits is generated by the supply of the power supply Vcc as illustrated as a transmission circuit consumption current (lane #2) in the drawing. This consumption current is the operation current for the operations of the circuits.

On the other hand, the slow current superimposition circuit 300 generates the slow starting/shutdown current 350 as a slow current in which a current value gradually increases in a period from the time t₁₀₁ to the time t₁₀₂ in response to the switching of the aligned signal #2 from the value “0” to the value “1” at the time t₁₀₁ and the switching of the transmission control signal 450 from the value “0” to the value “1” at the time t₁₀₂. The slow current superimposition circuit 300 superimposes the generated slow starting/shutdown current 350 on the power supply supplied to the parallel-serial conversion circuit 31₂ and the transmission circuit 32₂ of the lane #2.

As a result of the superimposition of the slow starting/shutdown current 350 on the power supply, a current value of a current Icc supplied to the parallel-serial conversion circuit 31₂ and the transmission circuit 32₂ gradually increases from, for example, 0 from the time t₁₀₁ at which the aligned signal #2 is switched from the value “0” to the value “1” toward the time t₁₀₂ at which the transmission control signal (lane #2) is switched from the value “0” to “1”, and reaches a current value of the operation current of the parallel-serial conversion circuit 31₂ and the transmission circuit 32₂ at the time t₁₀₂.

At the time t₁₀₂, the slow current superimposition circuit 300 returns the current value of the slow starting/shutdown current 350 to the current value before the increase at the time t₁₀₁ (such as 0). The current supplied to the parallel-serial conversion circuit 31₂ and the transmission circuit 32₂ is switched from the slow starting/shutdown current 350 from the slow current superimposition circuit 300 to the current by the power supply Vcc at the time t₁₀₂, and the operation current is maintained.

The same applies to a case where the lane #2 transitions from the communication state to the standby state with respect to the lane #1 in the communication state. That is, when the lane #2 transitions from the communication state to the standby state at time t₁₀₃ in FIG. 21, the aligned signal #2 switches from the value “1” to the value “0”. The transmission control circuit 400 switches the value of the transmission control signal (lane #2) corresponding to the lane #2 from “1” to “0” according to the time t₁₀₃ at which the aligned signal #2 is switched to the value “0”.

The operations of the parallel-serial conversion circuit 31₂ and the transmission circuit 32₂ of the lane #2 are stopped when the transmission control signal (lane #2) becomes the value “0” at the time t₁₀₃. When the operations of the parallel-serial conversion circuit 31₂ and the transmission circuit 32₂ are stopped, the generation of the consumption current due to the supply of the power supply Vcc ends.

On the other hand, in response to the switching of the aligned signal #2 from the value “1” to the value “0” at the time t₁₀₃, the slow current superimposition circuit 300 generates the slow starting/shutdown current 350 as a slow current a current value of which gradually decreases in a period from the time t₁₀₃ to time t₁₀₄ at which a predetermined time elapses from the time t₁₀₃. The slow current superimposition circuit 300 superimposes the generated slow starting/shutdown current 350 on the power supply supplied to the parallel-serial conversion circuit 31₂ and the transmission circuit 32₂ of the lane #2.

As a result of the superimposition of the slow starting/shutdown current 350 on the power supply, the current value of the current Icc supplied to the parallel-serial conversion circuit 31₂ and the transmission circuit 32₂ gradually decreases from the operation current of the parallel-serial conversion circuit 31₂ and the transmission circuit 32₂ from the time t₁₀₃ to the time t₁₀₄, and becomes, for example, 0 at the time t₁₀₄.

As described above, on the consumption current of the parallel-serial conversion circuit 31₂ and the transmission circuit 32₂, the slow starting/shutdown current 350 the current value of which gradually increases from 0 to the current value of the operation current at the start of the operations of the parallel-serial conversion circuit 31₂ and the transmission circuit 32₂ and gradually decreases from the current value of the operation current to 0 at the end of the operations is superimposed. As a result, as illustrated in portions 500 and 501 in the drawing, it is possible to control a steep change in the current Icc due to an increase in the number of lanes and the start of the operations of the parallel-serial conversion circuit 31₂ and the transmission circuit 32₂ which change causes the noise 36.

### 3-3. Specific Example of the Second Embodiment

Next, the configuration and operation according to the second embodiment will be described more specifically.

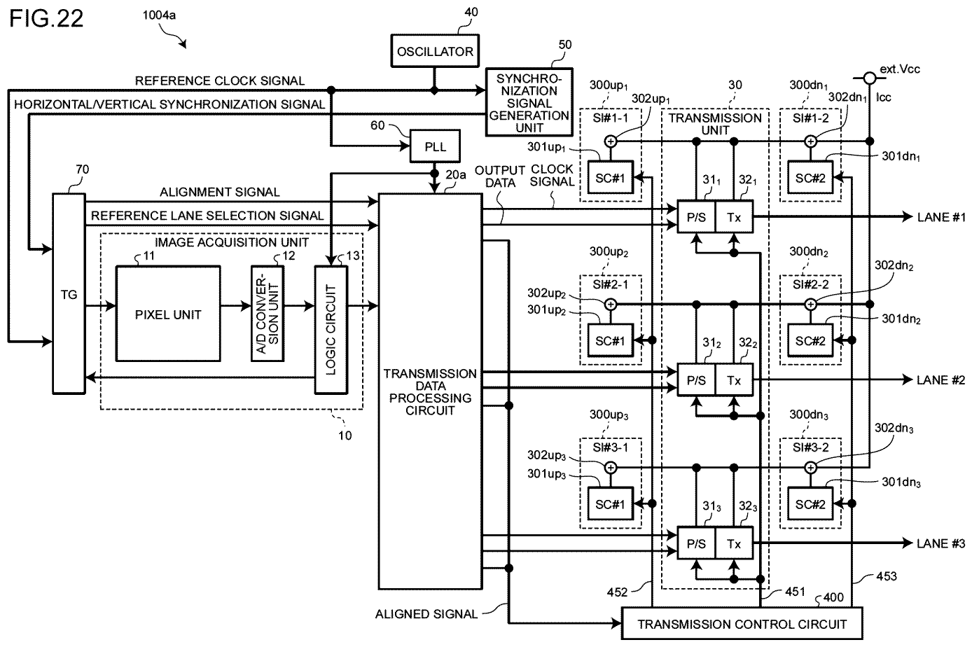

FIG. 22 is a block diagram more specifically illustrating the exemplary configuration of the image sensor 1004a according to the second embodiment. In FIG. 22, a configuration on a left side of the transmission data processing circuit 20a and the synchronization signal generation unit 50 is the same as that in FIG. 20A described above. On the other hand, in FIG. 22, the slow current superimposition circuit 300 in FIG. 20A is illustrated separately, for the first lane, the second lane, and the third lane, as slow current superimposition circuits 300up₁, 300up₂, and 300up₃ that increase the current and slow current superimposition circuits 300dn₁, 300dn2, and 300dn₃ that decrease the current value.

In FIG. 22, the transmission control circuit 400 generates an enable signal 451, a startup signal 452, and a shutdown signal 453 as the transmission control signal 450. The enable signal 451, the startup signal 452, and the shutdown signal 453 may be signals of the number of bits corresponding to the number of lanes that can be supported by a transmission unit 30. In the example of FIG. 22, the transmission unit 30 supports the transmission of the three lanes that are the lanes #1 to #3, and each of the enable signal 451, the startup signal 452, and the shutdown signal 453 is a 3-bit signal, and controls parallel-serial conversion and transmission in a lane corresponding to a bit position.

In FIG. 22, the slow current superimposition circuit 300up₁ (also described as SI #1-1 in the drawing) includes a slow current generation unit 301up₁ (also described as SC #1 in the drawing) and a superimposition unit 302up₁. The slow current generation unit 301up₁ generates a slow current in which the current gradually increases according to a value of the bit corresponding to the lane #1 of the startup signal 452.

The superimposition unit 302up₁ superimposes the slow current generated by the slow current generation unit 301up₁ on the power supply Vcc supplied to the parallel-serial conversion circuit 31₁ and the transmission circuit 32₂.

Similarly to the slow current superimposition circuit 300up₁, the slow current superimposition circuits 300up₂ and 30up₃ also include a slow current generation unit 301up₂ and a superimposition unit 302up₂, and a slow current generation unit 301up₃ and a superimposition unit 302up₃, respectively. Each of the slow current generation units 301up₂ and 301up₃ generates a slow current in which the current gradually increases according to a value of the bit of the corresponding lane of the startup signal 452.

The superimposition unit 302up₂ superimposes the slow current generated by the slow current generation unit 301up₂ on the power supply Vcc supplied to the parallel-serial conversion circuit 31₂ and the transmission circuit 32₂ of the lane #2. Similarly, the superimposition unit 302up₃ superimposes the slow current generated by the slow current generation unit 301up₃ on the power supply Vcc supplied to the parallel-serial conversion circuit 31₃ and the transmission circuit 32₃ of the lane #3.

In FIG. 22, the slow current superimposition circuit 300dn₁ (also described as SI #2-1 in the drawing) includes a slow current generation unit 301dn₁ (also described as SC #2 in the drawing) and a superimposition unit 302dn₁, similarly to the slow current superimposition circuit 300up₁. The slow current generation unit 301dn₁ generates a slow current in which the current gradually decreases according to the value of the bit corresponding to the lane #1 of the shutdown signal 453.

The superimposition unit 302dn₁ superimposes the slow current generated by the slow current generation unit 301dn₁ on the power supply Voc supplied to the parallel-serial conversion circuit 31₁ and the transmission circuit 32₂.

Similarly to the slow current superimposition circuit 300dn₁, the slow current superimposition circuits 300dn₂ and 300dn₃ also include a slow current generation unit 301dn₂ and a superimposition unit 302dn₂, and a slow current generation unit 301dn₃ and a superimposition unit 302dn₃, respectively. Each of the slow current generation units 301dn₂ and 301dn₃ generates the slow current in which the current gradually decreases according to the value of the bit of the corresponding lane of the shutdown signal 453.

The superimposition unit 302dn₂ superimposes the slow current generated by the slow current generation unit 301dn₂ on the power supply Vcc supplied to the parallel-serial conversion circuit 31₂ and the transmission circuit 32₂ of the lane #2. Similarly, the superimposition unit 302dn₃ superimposes the slow current generated by the slow current generation unit 301dn₃ on the power supply Vcc supplied to the parallel-serial conversion circuit 31₃ and the transmission circuit 32₃ of the lane #3.

In the following description, in a case where there is no specific need to distinguish, the slow current superimposition circuits 300up₁ to 300up₃ are described as the slow current superimposition circuit 300up, and the slow current superimposition circuits 300dn₁ to 300dn₃ are described as the slow current superimposition circuit 300dn.

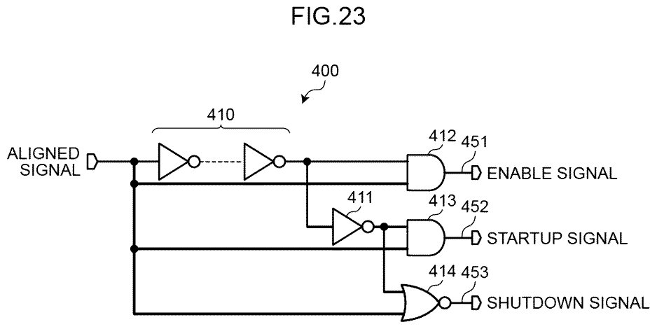

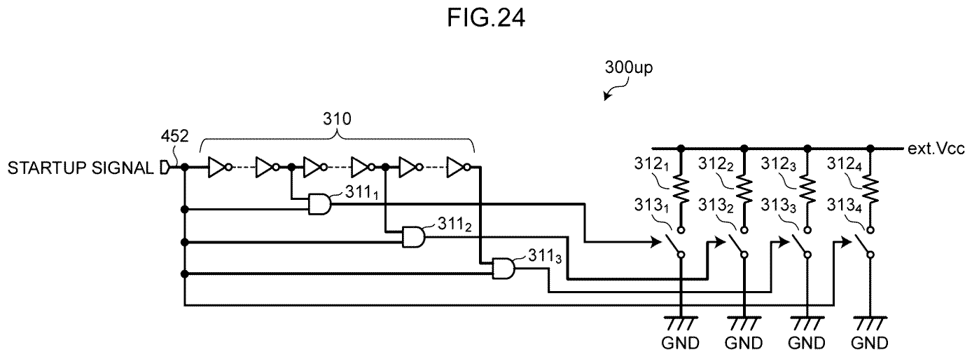

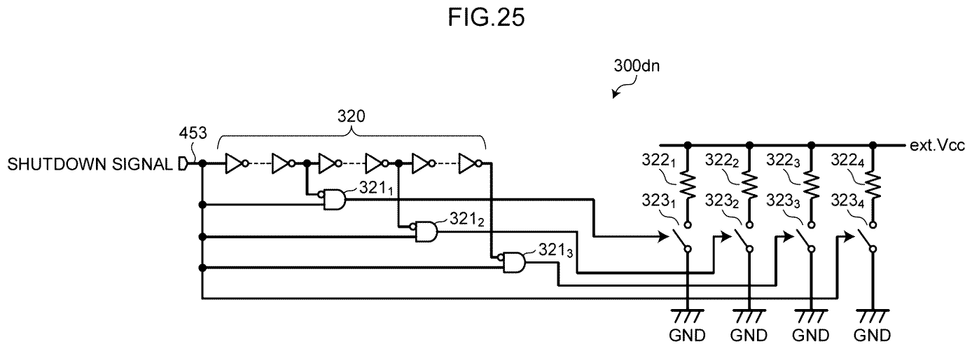

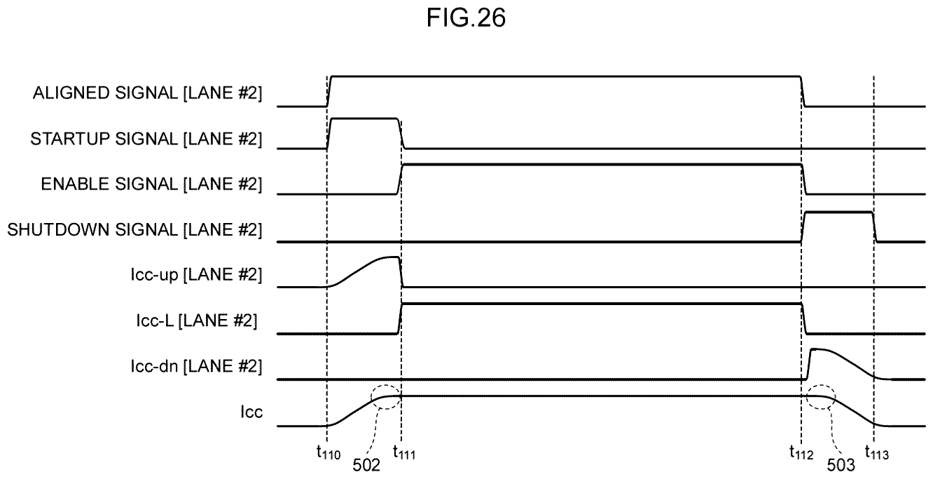

Specific configurations of the transmission control circuit 400 and the slow current superimposition circuits 300up and 300dn according to the second embodiment and operations of these circuits will be described with reference to FIG. 23 to FIG. 26. FIG. 23 is a circuit diagram illustrating an exemplary circuit of the transmission control circuit 400 applicable to the second embodiment. FIG. 24 and FIG. 25 are circuit diagrams illustrating exemplary circuits of the slow current superimposition circuits 300up and 300dn applicable to the second embodiment, respectively. FIG. 26 is a time chart for describing the operation according to the second embodiment. Note that the lane #2 among the lanes #1 to #3 is illustrated as an example in FIG. 26.

In FIG. 23, the transmission control circuit 400 includes a delay circuit 410 in which even number of inverter circuits are connected in series, an inverter circuit 411, AND circuits 412 and 413, and a NOR circuit 414. The aligned signal is supplied to the transmission control circuit 400, and is input to the delay circuit 410, one input terminal of each of the AND circuits 412 and 413, and one input terminal of the NOR circuit 414. The aligned signal is set to a value “1” (high state) in a period from time t₁₁₀ to time t₁₁₂.

The aligned signal delayed by the delay circuit 410 is input to the other input terminal of the AND circuit 412. The AND circuit 412 outputs, as the enable signal 451, logical conjunction of the aligned signal input to the one input terminal and the aligned signal delayed and input to the other input terminal. As illustrated in FIG. 26, the enable signal 451 is a signal having a value “1” (high state) in a period from time t₁₁₁ to time t₁₁₃. The parallel-serial conversion circuit 31₂ and the transmission circuit 32₂ of the lane #2 are operated in the period in which the enable signal 451 has the value “1”, and a consumption current is generated.

The aligned signal delayed by the delay circuit 410 is inverted by the inverter circuit 411 and input to the other input terminal of the AND circuit 413 and the other input terminal of the NOR circuit 414. The AND circuit 413 outputs, as the startup signal 452, logical conjunction of the output of the inverter circuit 411 and the aligned signal. In addition, the NOR circuit 414 outputs, as the shutdown signal 453, NOR of the output of the inverter circuit 411 and the aligned signal.

Referring to FIG. 26, the aligned signal changes from the value “0” (low state) to the value “1” (high state) at the time t₁₁₀, and the aligned signal (not illustrated) delayed by the delay circuit 410 changes from the value “0” (low state) to the value “1” (high state) at the time t₁₁₁. The startup signal 452 is set to the value “1” (high state) in a period from the time t₁₁₀ to the time t₁₁₁ by the logical conjunction of the aligned signal and the signal acquired by delaying of the aligned signal.

On the other hand, the aligned signal changes from the value “1” to the value “0” at the time t₁₁₂, and the aligned signal delayed by the delay circuit 410 changes from the value “1” to the value “0” at the time t₁₁₃. The enable signal 451 has the value “1” in the period from the time t₁₁₁ to the time the by the logical conjunction of the aligned signal and the delayed aligned signal. In addition, the shutdown signal 453 is set to the value “1” in a period from the time t₁₁₂ to the time t₁₁₃ by NOR of the aligned signal and the delayed and inverted aligned signal.

Note that there is a characteristic that jitter in a communication signal increases when a slope of an increase or decrease of the current value due to the slow current is steep to some extent or more, and generation of the jitter decreases from a certain slope when the slope is made gentle. Thus, the slope, that is, the length of the period of the time t₁₁₀ to t₁₁₁ and the period of the time t₁₁₂ to t₁₁₃ may be determined on the basis of the slope at which the generation of the jitter decreases. For example, these periods may be the shortest time in which the generation of the jitter decreases. In addition, the lengths of these periods may be adjusted on the basis of a value written in a register or the like.

Referring to FIG. 24, the slow current superimposition circuit 300up includes a delay circuit 310 in which a plurality of inverter circuits is connected in series, a plurality of AND circuits 311₁, 311₂, and 311₃, and a resistor 312₁ and a switch circuit 313₁, a resistor 312₂ and a switch circuit 313₂, and a resistor 312₃ and a switch circuit 313₃ that are connected in series respectively. Note that resistance values of the resistors 312₁ to 312₄ and delay time in the delay circuit 310 are arbitrary, and may be appropriately set according to a circuit characteristic and a required characteristic.

The startup signal 452 is input to the delay circuit 310 and one input terminal of each of the AND circuits 311₁, 311₂, and 311₃, and is set as a control signal of controlling opening and closing of the switch circuit 313₄. The startup signal 452 is delayed in a predetermined manner and extracted by the delay circuit 310, and is input to an input terminal of the other end of each of the AND circuits 311₁, 311₂, and 311₃. The AND circuits 311₁, 311₂, and 311₃ output logical conjunction of the signals input to one and the other input terminals as control signals of controlling opening and closing of the switch circuits 313₁, 313₂, and 313₃, respectively.

On the other hand, one end of each of the resistor 312₁ and the switch circuit 313₁, the resistor 312₂ and the switch circuit 313₂, and the resistor 312₃ and the switch circuit 313₃ connected in series is connected to the power supply Vcc, and the other end thereof is connected to ground potential GND. Each of the switch circuits 313₁ to 313₄ is sequentially controlled to be open and closed in accordance with the startup signal 452 and each of control signals output from the AND circuits 311₁ to 311₃ at timing at which the startup signal 452 is sequentially delayed, whereby a slow current Icc-up in which the current gradually increases from the time t₁₁₀ toward the time t₁₁₁ is generated and supplied to a power supply line of the power supply Vcc.

Referring to FIG. 25, the slow current superimposition circuit 300dn includes a delay circuit 320 in which a plurality of inverter circuits is connected in series, a plurality of AND circuits 321₁, 321₂, and 321₃, and a resistor 322₁ and a switch circuit 323₁, a resistor 322₂ and a switch circuit 323₂, and a resistor 322₃ and a switch circuit 323₃ that are connected in series respectively. Note that resistance values of the resistors 322₁ to 322₄, and delay time in the delay circuit 320 are arbitrary, and may be appropriately set according to a circuit characteristic and a required characteristic.

The shutdown signal 453 is input to the delay circuit 320 and a non-inversion input terminal of each of the AND circuits 321₁, 321₂, and 321₃, and is set as a control signal that controls opening and closing of the switch circuit 323₄. The shutdown signal 453 is delayed in a predetermined manner and extracted by the delay circuit 320, and is input to an inversion input terminal of each of the AND circuits 321₁, 321₂, and 321₃. The AND circuits 321₁, 321₂, and 321₃ output logical conjunction of the signals input to the non-inversion input terminals and the inversion input terminals as control signals of controlling opening and closing of the switch circuits 323₁, 323₂, and 323₃, respectively.

On the other hand, one end of each of the resistor 322₁ and the switch circuit 323₁, the resistor 322₂ and the switch circuit 323₂, and the resistor 322₃ and the switch circuit 323₃ connected in series is connected to the power supply Vcc, and the other end thereof is connected to the ground potential GND. Each of the switch circuits 323₁ to 323₄ is sequentially controlled to be open and closed in accordance with the shutdown signal 453 and each of control signals output from the AND circuits 321₁ to 321₃ at timing at which the shutdown signal 453 is sequentially delayed, whereby a slow current Icc-dn in which the current gradually decreases from the time t₁₁₂ toward the time t₁₁₃ is generated and supplied to the power supply line of the power supply Vcc.

As illustrated in FIG. 26, during the period in which the enable signal 451 has the value “1” (time t₁₁₁ to time t₁₁₂), the parallel-serial conversion circuit 312 and the transmission circuit 322 of the lane #2 are operated, and a consumption current Icc-L is generated. In the second embodiment, before and after the period in which the enable signal 451 has the value “1”, the slow current Icc-up a current value of which increases and the slow current Icc-dn a current value of which decreases are superimposed on Vcc.

In the second embodiment, as a result, even in a case where the standby state and the communication state are switched in the lane #2, as illustrated in portions 502 and 503 of FIG. 26, it is possible to control a steep fluctuation in the current Icc supplied to the parallel-serial conversion circuit 31₂ and the transmission circuit 32₂ of the lane #2 by the power supply Vcc. Thus, it is possible to prevent generation of chattering 35 due to switching between the standby state and the communication state in the lane, and it is possible to prevent propagation of the noise 36 to another lane due to the chattering 35.

In addition, in the second embodiment, since it is possible to control the steep change in the current at the time of switching the number of lanes to which image data is transferred, it is possible to improve resistance to electromagnetic wave radiation such as electromagnetic interference (EMI) or in-flight interference in an aircraft.

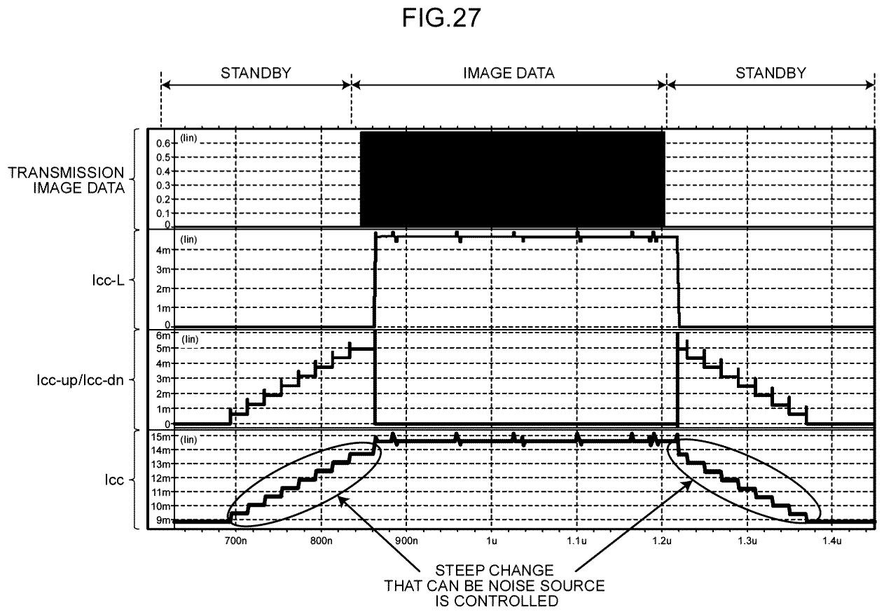

FIG. 27 is a schematic diagram illustrating an example of simulating an operation by a configuration according to the second embodiment. Elapse of time is illustrated in a right direction in FIG. 27.

In FIG. 27, the uppermost row represents transmission image data, and it is indicated that the image data is transmitted during a period of the communication state. The second row represents the consumption current Icc-L in the parallel-serial conversion circuit and the transmission circuit in the lane. The consumption current Icc-L is generated in response to the transmission timing of the image data, and is 0 in the standby state. In the third row, the slow current Icc-up of the current increase and the slow current Icc-dn of the current decrease are illustrated.

In FIG. 27, a first half of the third row represents the slow current Icc-up of the current increase. It can be seen that the current value of the slow current Icc-up gradually increases to the current value of the consumption current Icc-L in a period from a predetermined time before the consumption current Icc-L is generated until the consumption current Icc-L is generated, and the current value is set to 0 when the consumption current Icc-L is generated. Similarly, a latter half of the third row represents the slow current Icc-dn of the current decrease, and it can be seen that the current value gradually decreases from the current value of the consumption current Icc-L to 0 in a period of a predetermined time from an end of the generation of the consumption current Icc-L.

In FIG. 27, a fourth row represents the current Icc in which the slow currents Icc-up and Icc-dn are superimposed on the consumption current Icc-L. The parallel-serial conversion circuit and the transmission circuit in the lane are driven by the current Icc. As illustrated in the drawing, it can be seen that the slow currents Icc-up and Icc-dn before and after the consumption current Icc-L controls the steep change in the current at the time of the lane switching which change may be a factor of the noise 36.

Note that although the slow current superimposition circuit 300 generates the slow current in which the current is changed gradually in the above description, this example is not a limitation. For example, the slow current superimposition circuit 300 may generate a slow current in which the current is continuously changed.

### 3. CONCLUSION

As described above, according to the present disclosure, the alignment signal is provided in each lane of the output by the transmission unit 30 that performs the serial transfer, and the other lanes are aligned, that is, synchronized on the basis of the clock of the reference lane.

Thus, by applying the configuration of each of the embodiments according to the present disclosure, it becomes possible to synchronize the image data to be serially transferred in parallel without using a synchronization code in the data transfer and further without separately providing a synchronization adjustment circuit on the reception side. As a result, it is possible to eliminate a process and redundant data that hinder an increase in speed, to efficiently transfer data by using a plurality of lanes, and to process a large amount of data at high speed.

In addition, by application of the configuration of each of the embodiments according to the present disclosure, a synchronization adjustment process performed between lanes on the reception side and a circuit to realize that become unnecessary. Thus, it becomes possible to reduce a size and power consumption of a device, and to realize cost reduction by reducing an area of the circuit.

Since having the above-described effects, the configuration of each of the embodiments according to the present disclosure is suitable for use in an image sensor that needs to process a large amount of data at high speed. In addition, since it is possible to reduce the size and power consumption of the device, it is suitable for use in a mobile product.

Furthermore, the configuration of each of the embodiments according to the present disclosure can be applied to various interfaces that perform serial transfer in parallel in a plurality of lanes, such as Mobile Industry Processor Interface (MIPI), Peripheral Component Interconnect express (PCIe), DisplayPort, a universal serial bus (USB), Thunderbolt (registered trademark), and High-Definition Multimedia Interface (HDMI) (registered trademark).

Note that the effects described in the present description are merely examples and are not limitations, and there may be another effect.

Note that the present technology can also have the following configurations.
(1) A communication device comprising:
   a plurality of signal processing units each of which outputs an output clock signal and output data that is based on input data and synchronized with the output clock signal to a corresponding lane among a plurality of lanes; and
   a first selection circuit that selects, according to a reference lane selection signal to select a reference lane from the plurality of lanes, an output clock signal corresponding to the reference lane among the output clock signals respectively output from the plurality of signal processing units, and performs an output thereof to each of the plurality of signal processing units, wherein
   each of the plurality of signal processing units aligns and outputs the output clock signal and the output data on a basis of either a reference clock signal or the output clock signal output from another signal processing unit among the plurality of signal processing units.
(2) The communication device according to the above (1), wherein
   a first signal processing unit corresponding to the reference lane among the plurality of signal processing units
   performs the alignment on the output clock signal and the output data on a basis of the reference clock signal, and performs the output thereof, and
   a second signal processing unit different from the first signal processing unit among the plurality of signal processing units
   performs the alignment on the output clock signal and the output data on a basis of the output clock signal output from the first signal processing unit, and performs the output thereof.
(3) The communication device according to the above (1) or (2), wherein
   each of the plurality of signal processing units
   selects one of the reference clock signal or the output clock signal output from the first selection circuit according to the reference lane selection signal, and generates, on a basis of the selected clock signal, a synchronization clock signal for synchronizing an alignment signal a state of which changes in response to timing of designating a lane for a data transfer among the plurality of lanes.
(4) The communication device according to the above (3), wherein
   each of the plurality of signal processing units
   generates an aligned signal acquired by synchronization of timing, at which the state of the alignment signal changes, with the synchronization clock signal.
(5). The communication device according to the above (4), wherein
   the output data is output to a transmission unit that transmits the output data to a subsequent circuit corresponding to the lane,
   the communication device further comprising a control unit that controls a start and a stop of an operation of the transmission unit with reference to timing at which a state of the aligned signal changes, and designates first timing at which the state of the aligned signal changes and second timing at which a predetermined time elapses from the first timing, and
   a slow current superimposition unit that generates a slow current a current value of which gradually changes from the first timing toward the second timing, and that superimposes the slow current on a power supply current supplied to the transmission unit.
(6). The communication device according to the above (5), wherein
   the control unit
   designates the first timing and the second timing for each of the start and the stop of the operation of the transmission unit.
(7) The communication device according to the above (6), wherein
   the slow current superimposition unit
   superimposes a current, which gradually increases from the first timing toward the second timing, on the power supply current at the first timing and the second timing designated for the start of the operation of the transmission unit, and
   superimposes a current, which gradually decreases from the first timing toward the second timing, on the power supply current at the first timing and the second timing designated for the stop of the operation of the transmission unit.
(8) The communication device according to the above (7), wherein
   the control unit
   controls the transmission unit to be in an operating state in a period from the second timing designated for the start of the operation of the transmission unit to the first timing designated for the stop of the operation of the transmission unit.
(9) The communication device according to any one of the above (5) to (8), wherein
   the transmission unit includes
   a conversion unit that converts the output data from parallel data into serial data, and
   a transmission unit that transmits the serial data to the subsequent circuit
   for each of the plurality of lanes.
(10) The communication device according to any one of the above (4) to (9), wherein
   each of the plurality of signal processing units
   switches validity and invalidity of the reference clock signal according to the aligned signal, and generates the output clock signal on a basis of the reference clock signal of a case of being set to be valid.
(11) The communication device according to the above (10), wherein
   each of the plurality of signal processing units
   outputs the input data as the output data in synchronization with the output clock signal.
(12) The communication device according to any one of the above (1) to (11), wherein
   identification information for identifying timing of designating a lane for a data transfer among the plurality of lanes is arranged in a head portion of the output data.
(13) The communication device according to any one of the above (1) to (12), wherein
   the input data is image data.
(14) A communication method comprising:
   an output step of outputting an output clock signal and output data that is based on input data and synchronized with the output clock signal to a corresponding lane among a plurality of lanes; and
   a first selection step of selecting, according to a reference lane selection signal to select a reference lane from the plurality of lanes, an output clock signal corresponding to the reference lane among the output clock signals respectively output from a plurality of signal processing units, and performing an output thereof to each of the plurality of signal processing units,
   the steps being performed by each of the plurality of signal processing units, wherein
   in the output step, each of the plurality of signal processing units
   outputs the output clock signal and the output data on a basis of either a reference clock signal or the output clock signal output from another signal processing unit among the plurality of signal processing units.
(15) An image sensor comprising:
   an imaging unit that outputs image data corresponding to emitted light;
   a plurality of signal processing units to each of which the image data is input as input data, and each of which outputs an output clock signal and output data that is based on the input data and synchronized with the output clock signal to a corresponding lane among a plurality of lanes; and
   a first selection circuit that selects, according to a reference lane selection signal to select a reference lane from the plurality of lanes, an output clock signal corresponding to the reference lane among the output clock signals respectively output from the plurality of signal processing units, and performs an output thereof to each of the plurality of signal processing units, wherein
   each of the plurality of signal processing units
   aligns and outputs the output clock signal and the output data on a basis of either a reference clock signal or the output clock signal output from another signal processing unit among the plurality of signal processing units.

### REFERENCE SIGNS LIST

10 IMAGE ACQUISITION UNIT
20 TRANSMISSION DATA PROCESSING CIRCUIT
21₁, 21₂, 21₃ SIGNAL PROCESSING CIRCUIT
30 TRANSMISSION UNIT
31₁, 31₂, 31₃ PARALLEL-SERIAL CONVERSION CIRCUIT
32₁, 32₂, 32₃ TRANSMISSION CIRCUIT
40 OSCILLATOR
50 SYNCHRONIZATION SIGNAL GENERATION UNIT
60 PLL
70 TIMING GENERATOR
80 RECEPTION UNIT
81₁, 81₂, 81₃ RECEPTION CIRCUIT
82₁,82₂, 82₃ SERIAL-PARALLEL CONVERSION CIRCUIT
90 RECEPTION DATA PROCESSING CIRCUIT
200₁, 200₂, 200₃, 204 SELECTOR
201₁, 201₂, 201₃ SYNCHRONIZATION CIRCUIT
202₁, 202₂, 202₃ CLOCK ALIGNMENT CIRCUIT
203₁, 203₂, 203₃ DATA ALIGNMENT CIRCUIT
210₁, 210₂, 210ₙ, 230 FLIP-FLOP CIRCUIT
220 AND CIRCUIT
221 FREQUENCY DIVIDER
300, 300dn, 300dn₁, 300dn₂, 300dn₃, 300up, 300up₁, 300up₂, 300up₃ SLOW CURRENT SUPERIMPOSITION CIRCUIT
350 SLOW STARTING/SHUTDOWN CURRENT
400 TRANSMISSION CONTROL CIRCUIT
450 TRANSMISSION CONTROL SIGNAL
451 ENABLE SIGNAL
452 STARTUP SIGNAL
453 SHUTDOWN SIGNAL
1004, 1004a IMAGE SENSOR
1005 IMAGE PROCESSING UNIT

1. A communication device comprising:
a plurality of signal processing units each of which outputs an output clock signal and output data that is based on input data and synchronized with the output clock signal to a corresponding lane among a plurality of lanes; and
a first selection circuit that selects, according to a reference lane selection signal to select a reference lane from the plurality of lanes, an output clock signal corresponding to the reference lane among the output clock signals respectively output from the plurality of signal processing units, and performs an output thereof to each of the plurality of signal processing units, wherein
each of the plurality of signal processing units
aligns and outputs the output clock signal and the output data on a basis of either a reference clock signal or the output clock signal output from another signal processing unit among the plurality of signal processing units.

2. The communication device according to claim 1, wherein
a first signal processing unit corresponding to the reference lane among the plurality of signal processing units
performs the alignment on the output clock signal and the output data on a basis of the reference clock signal, and performs the output thereof, and
a second signal processing unit different from the first signal processing unit among the plurality of signal processing units
performs the alignment on the output clock signal and the output data on a basis of the output clock signal output from the first signal processing unit, and performs the output thereof.

3. The communication device according to claim 1, wherein
each of the plurality of signal processing units
selects one of the reference clock signal or the output clock signal output from the first selection circuit according to the reference lane selection signal, and generates, on a basis of the selected clock signal, a synchronization clock signal for synchronizing an alignment signal a state of which changes in response to timing of designating a lane for a data transfer among the plurality of lanes.

4. The communication device according to claim 3, wherein
each of the plurality of signal processing units
generates an aligned signal acquired by synchronization of timing, at which the state of the alignment signal changes, with the synchronization clock signal.

5. The communication device according to claim 4, wherein
the output data is output to a transmission unit that transmits the output data to a subsequent circuit corresponding to the lane,
the communication device further comprising
a control unit that controls a start and a stop of an operation of the transmission unit with reference to timing at which a state of the aligned signal changes, and designates first timing at which the state of the aligned signal changes and second timing at which a predetermined time elapses from the first timing, and
a slow current superimposition unit that generates a slow current a current value of which gradually changes from the first timing toward the second timing, and that superimposes the slow current on a power supply current supplied to the transmission unit.

6. The communication device according to claim 5, wherein
the control unit
designates the first timing and the second timing for each of the start and the stop of the operation of the transmission unit.

7. The communication device according to claim 6, wherein
the slow current superimposition unit
superimposes a current, which gradually increases from the first timing toward the second timing, on the power supply current at the first timing and the second timing designated for the start of the operation of the transmission unit, and
superimposes a current, which gradually decreases from the first timing toward the second timing, on the power supply current at the first timing and the second timing designated for the stop of the operation of the transmission unit.

8. The communication device according to claim 7, wherein
the control unit
controls the transmission unit to be in an operating state in a period from the second timing designated for the start of the operation of the transmission unit to the first timing designated for the stop of the operation of the transmission unit.

9. The communication device according to claim 5, wherein
the transmission unit includes
a conversion unit that converts the output data from parallel data into serial data, and
a transmission unit that transmits the serial data to the subsequent circuit
for each of the plurality of lanes.

10. The communication device according to claim 4, wherein
each of the plurality of signal processing units
switches validity and invalidity of the reference clock signal according to the aligned signal, and generates the output clock signal on a basis of the reference clock signal of a case of being set to be valid.

11. The communication device according to claim 10, wherein
each of the plurality of signal processing units
outputs the input data as the output data in synchronization with the output clock signal.

12. The communication device according to claim 1, wherein
identification information for identifying timing of designating a lane for a data transfer among the plurality of lanes is arranged in a head portion of the output data.

13. The communication device according to claim 1, wherein
the input data is image data.

14. A communication method comprising:
an output step of outputting an output clock signal and output data that is based on input data and synchronized with the output clock signal to a corresponding lane among a plurality of lanes; and
a first selection step of selecting, according to a reference lane selection signal to select a reference lane from the plurality of lanes, an output clock signal corresponding to the reference lane among the output clock signals respectively output from a plurality of signal processing units, and performing an output thereof to each of the plurality of signal processing units,
the steps being performed by each of the plurality of signal processing units, wherein
in the output step, each of the plurality of signal processing units
outputs the output clock signal and the output data on a basis of either a reference clock signal or the output clock signal output from another signal processing unit among the plurality of signal processing units.

15. An image sensor comprising:
an imaging unit that outputs image data corresponding to emitted light;
a plurality of signal processing units to each of which the image data is input as input data, and each of which outputs an output clock signal and output data that is based on the input data and synchronized with the output clock signal to a corresponding lane among a plurality of lanes; and
a first selection circuit that selects, according to a reference lane selection signal to select a reference lane from the plurality of lanes, an output clock signal corresponding to the reference lane among the output clock signals respectively output from the plurality of signal processing units, and performs an output thereof to each of the plurality of signal processing units, wherein
each of the plurality of signal processing units
aligns and outputs the output clock signal and the output data on a basis of either a reference clock signal or the output clock signal output from another signal processing unit among the plurality of signal processing units.
